(19) United States
(12) Patent Application Publication
(10) Pub. No.: US 2026/0311078 A1
(43) Pub. Date: Oct. 8, 2026

(54) CONTINUOUS SENSOR MONITORING FOR IDENTIFICATION OF PREDICTIVE ANOMALIES

(71) Applicant: Panasonic Well LLC, Palo Alto, CA (US)

(72) Inventor: Ramin Firoozye, San Francisco, CA (US)

(21) Appl. No.: 19/276,143

(22) Filed: Jul. 22, 2025

Related U.S. Application Data
(60) Provisional application No. 63/783,800, filed on Apr. 4, 2025.

(51) Int. Cl. G06Q 10/0631

(52) U.S. Cl. CPC G06Q 10/06311

(57) ABSTRACT

Systems and methods for automatically and continuously monitoring user data collected through different devices and sensors and analyzing the user data for identification of any predictive anomalies are provided. A user monitoring gateway implemented in a user environment continuously receives ambient data associated with a user from different devices and sensors in the user environment. The ambient data is processed to detect any predictive anomalies associated with the user. The predictive anomalies are associated with different categories and actions are performed to address the predictive anomalies.

### CROSS-REFERENCE TO RELATED APPLICATIONS

The present patent application claims the priority benefit of U.S. provisional patent application number 63/783,800 filed Apr. 4, 2025 and is related to U.S. Patent Applications entitled “SYSTEMS AND METHODS FOR AUTOMATED REVERSE EVENT DETECTION” (Attorney Docket No.: 109304-845022-008200US) filed Jul. 22, 2025, “AUTOMATED DISAMBIGUATION OF USERS IN A MULTI-TENANT ENVIRONMENT BASED ON SENSOR DATA” (Attorney Docket No.: 109304-845004-008400US) filed Jul. 22, 2025 and “DETECTING AND TRANSMITTING EVENTS ASSOCIATED WITH A SUBJECT” (Attorney Docket No.: 109304-845006-008500US) filed Jul. 22, 2025, U.S. Provisional Application 63/783,806 filed Apr. 4, 2025 entitled “SYSTEMS AND METHODS FOR AUTOMATED REVERSE EVENT DETECTION”, U.S. Provisional Application 63/783,809 filed Apr. 4, 2025 entitled “AUTOMATED DISAMBIGUATION OF USERS IN A MULTI-TENANT ENVIRONMENT BASED ON SENSOR DATA” and U.S. Provisional Application 63/783,798 filed Apr. 4, 2025 entitled “DETECTING AND TRANSMITTING EVENTS ASSOCIATED WITH A SUBJECT”, the disclosures of which are incorporated herein by reference in its entirety for all purposes.

### FIELD

The present disclosure relates to systems and methods for automatically and continuously monitoring user data collected through different devices and sensors and analyzing the user data for identification of any predictive anomalies.

### SUMMARY

Disclosed embodiments provide a framework for dynamically identifying predictive anomalies through the automatic and continuous monitoring of real-time ambient data from myriad devices and sensors in a user environment. According to some embodiments, a computer-implemented method is provided. The computer-implemented method comprises continuously receiving ambient data associated with a user. The ambient data is continuously received through a set of communications channels associated with different sensors and a gateway device. Further, the ambient data is continuously received to dynamically detect any predictive anomalies associated with the user. The computer-implemented method further comprises processing the ambient data through a machine learning algorithm to detect one or more predictive anomalies associated with the user. The machine learning algorithm is trained using a dataset of sample ambient data and corresponding sample predictive anomalies associated with the sample ambient data. The computer-implemented method further comprises associating the one or more predictive anomalies with a category according to a set of characteristics associated with the one or more predictive anomalies and the user. The computer-implemented method further comprises identifying one or more actions performable to address the one or more predictive anomalies. The one or more actions are identified according to the category and a set of preferences associated with the user. The computer-implemented method further comprises executing the one or more actions through the gateway device to address the one or more predictive anomalies.

In some embodiments, the one or more actions include transmitting one or more commands. Further, when the one or more commands are received at a device, the device executes the one or more commands to address the one or more predictive anomalies.

In some embodiments, the computer-implemented method further comprises receiving new ambient data associated with the user. The new ambient data is received after the one or more actions are executed. The computer-implemented method further comprises determining that the one or more predictive anomalies are ongoing. The computer-implemented method further comprises identifying new actions performable to address the one or more predictive anomalies.

In some embodiments, the category corresponds to a severity of the one or more predictive anomalies with regard to the user.

In some embodiments, the one or more actions include transmitting one or more notifications to a set of entities. Further, the set of entities is identified according to the category and the set of preferences.

In some embodiments, the computer-implemented method further comprises dynamically generating device data associated with the gateway device. The device data indicates a level of performance for the gateway device. The computer-implemented method further comprises automatically transmitting the device data. When the device data is received at a remote monitoring system, the remote monitoring system performs a set of functions according to the level of performance.

In some embodiments, the computer-implemented method further comprises parsing the ambient data into regulated data and unregulated data. The regulated data and the unregulated data are processed through the machine learning algorithm according to corresponding encryption requirements and access control policies.

In an embodiment, a system comprises one or more processors and memory including instructions that, as a result of being executed by the one or more processors, cause the system to perform the processes described herein. In another embodiment, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

FIG. 1 shows an illustrative example of an environment in which a user monitoring gateway processes in real-time or near real-time ambient data from different devices and sensors within a user environment to detect any predictive anomalies and to identify different actions performable to address the predictive anomalies in accordance with at least one embodiment;

FIG. 2 shows an illustrative example of an environment in which a user monitoring system of the user monitoring gateway performs segmentation of real-time ambient data according to different regulatory and policy requirements in accordance with at least one embodiment;

FIG. 3 shows an illustrative example of an environment in which a data segmentation module implemented by the user monitoring gateway performs segmentation of real-time ambient data according to the different types or categories of data included in the real-time ambient data in accordance with at least one embodiment;

FIG. 4 shows an illustrative example of an environment in which a user monitoring system implemented by a user monitoring gateway separates real-time ambient data into regulated and unregulated data in accordance with at least one embodiment;

FIG. 5 shows an illustrative example of an environment in which an event data notification system implemented by the user monitoring gateway transmits event data corresponding to a detected event to different recipients based on any applicable preferences in accordance with at least one embodiment;

FIG. 6 shows an illustrative example of an environment in which a gateway health monitoring system processes gateway data from a user monitoring gateway to monitor the health of the user monitoring gateway in accordance with at least one embodiment;

FIG. 7 shows an illustrative example of a process for classifying and processing observed data from different devices and sensors in a user environment in accordance with at least one or more embodiments;

FIG. 8 shows an illustrative example of a process for categorizing event data corresponding to different events detected within a user environment and transmitting the event data to different recipients according to the categorization in accordance with at least one embodiment;

FIG. 9 shows an illustrative example of a process for monitoring data associated with a user monitoring gateway to dynamically detect any possible issues with the user monitoring gateway in accordance with at least one embodiment;

FIG. 10 shows an illustrative example of an environment in which communications with members are processed in accordance with at least one embodiment; and

FIG. 11 shows a computing system architecture including various components in electrical communication with each other using a connection in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Disclosed embodiments may provide a framework to automatically identify and recommend tasks to a member of a task facilitation service in order to reduce the member's cognitive load. Through this framework, the task facilitation service can monitor communications between a member and an assigned representative to automatically identify possible tasks that can be performed for the benefit of the member. Further, the task facilitation service can automatically identify any additional information that may be required for the creation of these tasks. Once these tasks have been created, the task facilitation service can coordinate with the representative and/or third-party services to perform these tasks for the benefit of the member.

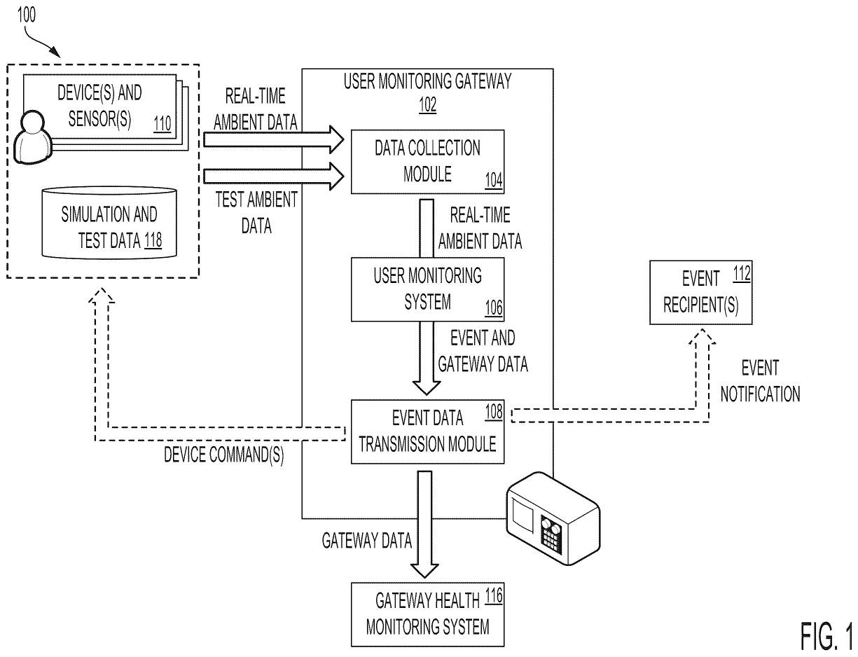

FIG. 1 shows an illustrative example of an environment 100 in which a user monitoring gateway 102 processes in real-time or near real-time ambient data from different devices and sensors 110 within a user environment to detect any predictive anomalies and to identify different actions performable to address the predictive anomalies in accordance with at least one embodiment. In the environment 100, a user monitoring gateway 102 may be implemented to dynamically, and in real-time or near real-time, monitor ambient data from different devices and sensors 110 implemented within a user environment to detect events associated with a user within the user environment (such as the user's home or any other location where the user monitoring gateway 102 is implemented). For instance, in an embodiment, the user monitoring gateway 102 is configured and implemented to automatically process ambient data from myriad devices and sensors 110 within a user environment to track the health and wellbeing of a particular user within the user environment. As an illustrative example, the user monitoring gateway 102 may continuously process ambient data from the myriad devices and sensors 110 within the user environment to detect any medical emergencies and accordingly transmit notifications to one or more event recipients 112 (e.g., medical personnel, caregivers, etc.) that may be able to address these medical emergencies. These notifications may be transmitted to the one or more event recipients 112 in series or in parallel based on the predictive anomaly detected (e.g., the severity of the predictive anomaly, the classification or type of predictive anomaly, the duration of the predictive anomaly, etc.). Further, the user monitoring gateway 102 may continuously process the ambient data from the myriad devices and sensors to monitor user activities within the user environment. For instance, the user monitoring gateway 102 may process this ambient data to dynamically track user movements and location within the user environment, track user activities within the user environment (e.g., eating, exercising, performing hygienic tasks, sleeping, etc.), and the like.

In an embodiment, the user monitoring gateway 102 transmits event data corresponding to a particular event detected within the user environment and associated with a particular user to different event recipients 112 based on different characteristics associated with the particular event. The event data may be transmitted to these different event recipients 112 based on a set of preferences corresponding to the particular user associated with the event. Returning to an illustrative example described above, if the particular event corresponds to a medical emergency associated with a user, the user monitoring gateway 102 may evaluate the user preferences associated with the user and determine that the data associated with the particular event (e.g., medical emergency) is to be transmitted to medical personnel which may be deployed to address the medical emergency. As another illustrative example, if the particular event corresponds to a user's lack of appetite (e.g., the user's eating habits have changed over a period of time, as detected by the user monitoring gateway 102), the user monitoring gateway 102 may evaluate the user preferences associated with the user and determine that the data associated with the particular event is to be transmitted to a caregiver associated with the user. The caregiver may use this data to further evaluate the user's eating habits and attend to the user to address the user's lack of appetite. As noted above, the event data may be transmitted to different event recipients 112 in series or in parallel based on the event detected (e.g., the severity of the event, the classification or type of event, the duration of the event, etc.).

In some instances, the user monitoring gateway 102 may transmit event data corresponding to any detected events within the user environment to a remote user monitoring system (not shown) that may broadcast the event data to different instances of a user health monitoring application implemented on different computing devices. The remote user monitoring system may maintain different user records corresponding to different users associated with the remote user monitoring system through which event data associated with these different users may be tracked and stored. The remote user monitoring system, in some instances, may provide user monitoring services for various users within different environments. For example, the remote user monitoring system may automatically coordinate with different user monitoring gateways (such as user monitoring gateway 102) to detect any user predictive anomalies that may be indicative of different issues related to a user (e.g., a medical emergency, a new medical condition, a need for assistance, etc.). Further, the remote user monitoring system may automatically coordinate with different user monitoring gateways to dynamically track user activities within these different environments to generate user baselines that may be used to detect, in real-time or near real-time, the aforementioned user predictive anomalies. In some instances, the remote user monitoring system may further coordinate communication with identified entities according to user preferences as defined during an onboarding process and/or through interaction with the user health monitoring application or with a web portal implemented by the remote user monitoring system.

The user monitoring gateway 102, in an embodiment, is a standalone computing device that is configured to interact with different devices and sensors 110 through corresponding communications channels to obtain and process ambient data within a user environment to detect and categorize different events occurring within the user environment. For example, the user monitoring gateway 102 may be connected to one or more Internet-of-Things (IoT) devices within the user environment. These connections (i.e., communications channels) may be established according to one or more IoT protocols. Example IoT protocols that may be implemented to facilitate the connections between the myriad IoT devices within the user environment and the user monitoring gateway 102 may include, but are not limited to, the Advanced Message Queuing Protocol (AMQP), Bluetooth®, Bluetooth® Low Energy (BLE), Zigbee, Z-Wave, Narrowband Internet of Things (NB-IoT), Matter, the Constrained Application Protocol (CoAP), the Data Distribution Service (DDS) protocol, LoRaWAN, Lightweight Machine-to-Machine (LWM2M) protocol, Message Queuing Telemetry Transport (MQTT), Wi-Fi, Near-Field Communication (NFC), and the like. IoT devices that may be implemented in a user environment may include, but are not limited to, home security devices (e.g., doorbell cameras, smart locks, alarm systems, etc.), home appliances (e.g., smart refrigerators, smart lights, smart televisions, smart speakers, smart washers and dryers, etc.), and the like.

The user monitoring gateway 102 may additionally be connected to one or more sensors within the user environment and through which the user monitoring gateway 102 may dynamically obtain ambient data. These one or more sensors may include, but are not limited to, home temperature sensors, air quality sensors, water monitoring sensors (e.g., leak detectors, water quality sensors, etc.), motion sensors, light sensors, audio-based sensors, door and window sensors, and the like. The one or more sensors may be connected to the user monitoring gateway 102 through one or more communications protocols, including any of the IoT protocols described above or other available communications protocols. For instance, the one or more sensors may be implemented on one or more of the IoT devices described above (e.g., a light sensor implemented on a smart television to determine a desired television brightness, a door sensor implemented on a smart refrigerator for detecting when the smart refrigerator is accessed, an air quality sensor implemented on a smart air conditioning/heating system, etc.). Thus, in some instances, the ambient data obtained from one or more sensors 110 may be included within the ambient data obtained from one or more IoT devices. In some instances, the ambient data from one or more sensors may be provided through standalone communications channels established between the user monitoring gateway 102 and these one or more sensors.

The user monitoring gateway 102 may further obtain ambient data through one or more cameras implemented within the user environment. These cameras may continuously, or in response to a triggering event, collect audiovisual data within and without the user environment. For example, the user environment may include a doorbell camera that may automatically record audiovisual data when a user is detected within a pre-defined range of the doorbell camera and/or when a user interacts with the doorbell camera. As another illustrative example, the user environment may include one or more cameras within different rooms that may automatically record audiovisual data when a user within the user environment enters any of these different rooms. In some instances, a camera within the user environment may be configured to automatically record any audiovisual data in the event of any sudden change in movement of a detected user within range of the camera. For example, if a camera detects a user within a particular room and the user suddenly falls to the ground (e.g., slips, faints, etc.), the camera may automatically detect this sudden fall and record the user. In some instances, the one or more cameras within the user environment may transmit any recorded audiovisual data to the user monitoring gateway 102 continuously or in response to a triggering event (such as the triggering events described above). The one or more cameras may be connected to the user monitoring gateway 102 through one or more communications protocols, including any of the IoT protocols described above or other available communications protocols. For instance, the one or more cameras may be implemented on one or more of the IoT devices described above. Alternatively, one or more cameras may be standalone devices through which standalone communications channels may be established with the user monitoring gateway 102.

The myriad devices and sensors 110 may further include personal devices associated with a user within the user environment associated with the user monitoring gateway 102. These personal devices may include, but are not limited to, personal fitness tracking devices, smartphones, smart watches, tablet computing devices, smart eyewear, augmented reality devices, wearable medical devices (e.g., glucose level monitors, blood pressure monitors, personal thermometers, electrocardiogram monitors, pacemakers, etc.), biosensors, and the like. These personal devices may be connected to the user monitoring gateway 102 through any of the communications protocols described herein. In an embodiment, when a user establishes a communications channel between a user's personal device and the user monitoring gateway 102, the user monitoring gateway 102 automatically associates the user's personal device with the particular user.

In an embodiment, the user monitoring gateway 102 implements a data collection module 104 that continuously, and in real-time or near real-time, obtains ambient data associated with the user environment from the various devices and sensors 110 implemented in the user environment. The data collection module 104 may comprise one or more computer systems of the user monitoring gateway 102 or may be implemented as an application or process executing on the user monitoring gateway 102. In some instances, the data collection module 104 may be implemented through various special-purpose components of the user monitoring gateway 102 that can facilitate real-time or near real-time collection and processing of different ambient data from any number of different devices and sensors 110 within the user environment and as the ambient data from these different devices and sensors is received.

In some instances, the data collection module 104 may obtain data from other user monitoring gateways implemented within the user environment. For example, a user may maintain multiple user monitoring gateways within different rooms in the user environment and that may dynamically act in tandem within the user environment to share any collected and processed data as the user moves within the user environment. The data collection module 104 may further interact with other user monitoring gateways operating outside of the user environment (such as in a user's vehicle or a portable device that the user can take with them outside of the user environment). These external user monitoring gateways may dynamically collect data associated with the user and with the user's present environment and provide this data to the data collection module 104 when the user returns to their native user environment. Through this data collection process, the data collection module 104 may continuously obtain and process different ambient data and user data as the user moves within and without the user environment.

In an embodiment, the data collection module 104 implements a set of libraries or other resources corresponding to different data formats utilized by different devices and sensors 110 compatible with the user monitoring gateway 102. For instance, the ambient data generated and transmitted by the myriad devices and sensors 110 within a user environment and connected to the user monitoring gateway 102 through different communications channels may be constructed using different data structures. The data collection module 104 may maintain a set of libraries or other resources that indicate these different data structures according to the types of devices and sensors from which the user monitoring gateway 102 may be connected to. For instance, the data collection module 104 may include one or more JavaScript Object Notation (JSON) libraries, Protocol Buffers (Protobuf), MQTT, Matter, Concise Binary Object Representation (CBOR) libraries, Binary JSON (BSON) libraries, Extensible Markup Language (XML) libraries, Comma-Separated Values (CSV) libraries, and the like. Additionally, the data collection module 104 may implement a set of libraries or other resources for processing semi-structured and unstructured data from different devices and sensors 110 within the user environment. For instance, the data collection module 104 may implement computer vision or other machine learning algorithms that are dynamically trained to process audiovisual data from different devices and sensors 110 within the multi-tenant environment to automatically identify various characteristics associated with the audiovisual data (e.g., user(s) within a room, voice signatures, etc.). As another illustrative example, the data collection module 104 may receive telemetry data or other IoT output from the one or more devices and sensors 110 that is unstructured and may necessitate format-specific algorithms or other processes for evaluating the telemetry data or other IoT output.

In an embodiment, the data collection module 104 implements a data cache that is configured to store real-time ambient data from the myriad devices and sensors 110 in the user environment. The real-time ambient data may be stored in the data cache for a limited period of time or based on data heuristics. For example, the data collection module 104 may implement a timer that may be used to define the amount of time ambient data may be stored in the data cache before the ambient data is automatically transmitted to a user monitoring system 106 for categorization and dissemination of the ambient data to different recipients. Additionally, or alternatively, the data collection module 104 may automatically transmit real-time ambient data from the data cache to the user monitoring system 106 in response to a triggering event. For example, the data collection module 104 may evaluate the ambient data to automatically detect any events occurring within the user environment.

In an embodiment, the data collection module 104 implements and dynamically trains a machine learning algorithm or artificial intelligence to detect any activities that a user may be engaged in. These activities may correspond to observed events occurring within the user environment. In some instances, the observed events may be routine for the user associated with the user monitoring gateway 102. As an illustrative example, the user may be known to routinely eat breakfast between 8:00 A.M. and 8:45 A.M. each day. Further, the user may be known to routinely move from their bedroom within the user environment to a bathroom between 7:00 A.M. and 7:15 A.M. for personal hygiene and to get ready to start their day. The data collection module 104 may further detect, from the ambient data, particular events that may not be related to a routine activity within the user environment. For example, through the aforementioned machine learning algorithm or artificial intelligence, the data collection module 104 may detect an event corresponding to a possible incident within the user environment that is not routine, such as an accident within the user environment. Further, through the aforementioned machine learning algorithm or artificial intelligence, the data collection module 104 may detect the absence of ambient data corresponding to different activities within the user environment. As an illustrative example, if ambient data corresponding to a particular room within the user environment is not representative of the presence of a user and/or of an activity occurring within the room, the data collection module 104 may generate synthetic data corresponding to the lack of activity within the room. This lack of activity, in some instances, may be indicative of a deviation from routine activities and movements within the user environment and, thus, may be indicative of an issue with the user within the user environment.

The machine learning algorithm or artificial intelligence implemented by the data collection module 104 may be dynamically trained using supervised, unsupervised, or hybrid training techniques. For instance, a dataset of sample ambient data (e.g., historical ambient data, hypothetical or artificial ambient data, combinations of historical and hypothetical/ambient data, etc.) and sample events (e.g., known events associated with the historical ambient data, hypothetical/artificial events associated with the hypothetical/artificial ambient data, combinations of known and hypothetical/artificial events, etc.) may be analyzed using a clustering or classification algorithm to classify the sample ambient data according to a set of different classifications (e.g., events). For instance, the machine learning algorithm or artificial intelligence may be dynamically trained in real-time by converting the sample ambient data into a set of embeddings and the sample events into a set of event embeddings. The machine learning algorithm or artificial intelligence may classify the sample ambient data according to one or more vectors of similarity between the set of embeddings and the set of event embeddings. In some instances, the machine learning algorithm or artificial intelligence may be implemented with a threshold that may be used to determine, based on the aforementioned embeddings and the one or more vectors of similarity, whether sample ambient data is sufficiently similar (e.g., satisfies the threshold by having a requisite amount of embeddings being within a level of tolerance of corresponding event embeddings for a particular known event) to a particular sample event. In some instances, the machine learning algorithm or artificial intelligence is further trained to detect the absence of ambient data, which may be indicative of an event. For instance, the dataset of sample ambient data may further include null or synthetic ambient data points that may correspond to particular events that represent deviations from routine activities and movements within a sample user environment.

In some instances, the clustering or classification of ambient data from different devices and sensors 110 can correspond to different health subsystems associated with different users (e.g., muscular systems, cardiovascular systems, digestive systems, skeletal systems, etc.), as well as physical attributes (e.g., limbs, organs, etc.). This additional clustering or classification of the ambient data may provide further context that may be used to evaluate ambient data in real-time to detect possible events or predictive anomalies.

In an embodiment, the machine learning algorithm or artificial intelligence implemented by the data collection module 104 is further trained using simulated and/or test ambient data from a simulation and test data repository 118. The simulated and/or test ambient data used to dynamically train or fine-tune the machine learning algorithm or artificial intelligence may include hypothetical or artificial ambient data corresponding to different devices and/or sensors that may be implemented in the user environment or that are otherwise compatible with the user monitoring gateway 102. In some instances, the simulated and/or test ambient data from the simulation and test data repository 118 may include raw sensor and device data from different devices and/or sensors implemented in different testing environments and that are implemented in these different testing environments to generate synthetic, simulated, and/or replay data. This simulated and/or test ambient data from the simulation and test data repository 118 may be used to enhance or supplement the dataset used to dynamically train and fine-tune the machine learning algorithm or artificial intelligence implemented by the data collection module 104. Through this continuous training process, the machine learning algorithm or artificial intelligence is enhanced to reduce the likelihood of the machine learning algorithm or artificial intelligence erroneously or falsely identifying anomalous events within the user environment during user performance of routine activities within the user environment (e.g., false positives). Similarly, this continuous training process may reduce the likelihood of the machine learning algorithm or artificial intelligence failing to detect anomalous events within the user environment (e.g., false negatives).

In an embodiment, through the machine learning algorithm or artificial intelligence, the data collection module 104 may perform such clustering or classification of ambient data from different devices and sensors 110 in the user environment in real-time or near real-time as the ambient data is received. Through this processing of the ambient data, the data collection module 104 may obtain partial matches among different known events to detect an event occurring within the user environment. Example classification and/or clustering algorithms that may be implemented include Support Vector Machines (SVM), k-Nearest Neighbor (KNN) algorithms, logistic regression algorithm, random forest models, Naïve Bayes models, linear regression models, decision tree models, gradient boosting machine models, and the like.

In an embodiment, if the data collection module 104 determines, through processing of the ambient data through the aforementioned machine learning algorithm or artificial intelligence, that an event requiring immediate attention has occurred or is ongoing, the data collection module 104 may automatically transmit this ambient data from the data cache to the user monitoring system 106 for further processing. Thus, for such events, the data collection module 104 may forego a timer-based trigger for transmitting the data corresponding to the event to the user monitoring system 106 and, in real-time or near real-time, transmit this data from the data cache to the user monitoring system 106. If the data collection module 104 determines, through processing of the ambient data through the aforementioned machine learning algorithm or artificial intelligence, that an event does not require immediate attention (e.g., the event corresponds to a routine activity within the user environment, the event is not classified as being associated with an emergency or otherwise requiring immediate attention, etc.), the data collection module 104 may maintain the ambient data associated with the particular event in the data cache subject to a timer-based trigger. The timer-based trigger may represent a limited period of time for which ambient data corresponding to an event may be stored in the data cache before the ambient data may be automatically transmitted to the user monitoring system 106 for further processing. Thus, through this classification of the ambient data in real-time or near real-time, the data collection module 104 optimizes the amount of data that is transmitted to the user monitoring system 106 at any time and according to any detected event. This, in turn, improves the functioning of the user monitoring system 106 as ambient data is throttled according to event urgency and timer-based triggers.

In an embodiment, the data collection module 104 can further monitor for the absence of ambient data that may be indicative of an event. For instance, if the data collection module 104 does not receive ambient data from one or more devices and/or sensors 110 within a pre-defined period of time, the data collection module 104 may dynamically generate synthetic ambient data that indicates an absence of ambient data from these one or more devices and/or sensors 110. This synthetic ambient data may be processed through the aforementioned machine learning algorithm or artificial intelligence to determine whether the absence of such ambient data corresponds to an event. Further, if the absence of such data is indicative of an event, the machine learning algorithm or artificial intelligence may generate an indication as to whether the event requires immediate attention. If the event does not require immediate attention, the data collection module 104 may maintain the synthetic ambient data in the data cache subject to a timer-based trigger.

The user monitoring system 106, in some instances, is implemented as an application or process executing on the user monitoring gateway 102 and is configured to process ambient data provided by the data collection module 104 for segmentation of the ambient data for identifying different events and determining what actions are to be performed in response to these different events. In some instances, the user monitoring system 106 may be implemented through various special-purpose components of the user monitoring gateway 102 that can facilitate real-time or near real-time processing of ambient data corresponding to different events to identify these different events and accordingly determine what actions may be performed in response to these different events. The actions performed by the user monitoring system 106 (as described in greater detail herein) are performed as the ambient data corresponding to different events is received.

In an embodiment, the user monitoring system 106 evaluates the ambient data obtained from the data collection module 104 to classify the ambient data according to different data attributes. For instance, the user monitoring system 106 may automatically perform data segmentation of the ambient data to determine whether the ambient data includes any data that is subject to different regulations, policies, or other restrictions on how this data may be processed, maintained, and disseminated to other entities. For example, certain data may be subject to Food and Drug Administration (FDA) policies, whereby any algorithms, applications, or other executable instructions that are implemented to process this data may require FDA certification such that any updates made to these algorithms, applications, or other executable instructions may result in a need for recertification of these algorithms, applications, or other executable instructions. As another illustrative example, certain health data associated with the user may be subject to Health Insurance Portability and Accountability Act (HIPAA) privacy requirements, which may limit the use and dissemination of certain data to different entities without user authorization. Further, even with user authorization, this data may require additional controls to ensure that the data is not inadvertently exposed to unauthorized entities during transmission to other systems.

To perform data segmentation of the real-time ambient data from the different devices and sensors 110, the user monitoring system 106 may implement and dynamically train a classification algorithm to divide the ambient data into distinct data segments according to different classifications of the ambient data. This machine learning algorithm or artificial intelligence may be dynamically trained using supervised, unsupervised, or hybrid training techniques. For instance, a dataset of sample ambient data (e.g., known or historical ambient data, hypothetical or artificial ambient data, combinations of known/historical and hypothetical/artificial ambient data, etc.) and sample data classifications according to different data attributes (e.g., known or historical data attributes, hypothetical data attributes, combinations of known/historical and hypothetical/artificial data attributes, etc.) may be generated for training of the machine learning algorithm or artificial intelligence. These different data attributes may include, for example, user-specific data (e.g., data corresponding to user interactions with different devices and/or sensors 110, biometric information, personally identifiable information (PII), etc.), user health data (e.g., data corresponding to user health metrics (e.g., pulse, oxygen levels, blood pressure, etc.), protected health information (PHI), etc.), and device-specific data (e.g., telemetry data corresponding to the performance of the devices and/or sensors 110, telemetry data corresponding to the user monitoring gateway 102, etc.).

In some instances, the dataset further includes additional data classifications that may serve as indications as to whether data is regulated (i.e., subject to one or more regulations, policies, or other restrictions) or unregulated. For example, data that is classified as being user health data may also be classified as being regulated and, thus, requiring separate processing and handling by the user monitoring gateway 102. As another illustrative example, data that is classified as being device-specific and not including sensitive user information may also be classified as being unregulated data that can be processed through any available methods implemented by the user monitoring gateway 102. Thus, the machine learning algorithm or artificial intelligence implemented by the user monitoring system 106 may be dynamically trained to perform an initial classification of the ambient data according to the data attributes of the ambient data and, subsequently, perform a second classification of the individual data segments according to the types of initial classifications assigned to the individual data segments.

In an embodiment, to dynamically train the machine learning algorithm or artificial intelligence used to segment and classify ambient data for processing by the user monitoring gateway 102, the user monitoring system 106 generates an initial iteration of the machine learning algorithm or artificial intelligence. For instance, the user monitoring system 106 may initialize a set of coefficients {α1, α2, α3, . . . αn} randomly according to a Gaussian distribution or non-Gaussian distribution. Using this initial iteration of the machine learning algorithm or artificial intelligence, the user monitoring system 106 may process the dataset of sample ambient data to generate an output. This output may specify, for each data point corresponding to a particular set of ambient data, a set of data segments and corresponding classifications for the set of data segments. The user monitoring system 106 may compare the output generated using the initial iteration of the machine learning algorithm or artificial intelligence to the sample data segments and corresponding classifications defined in the dataset for each of the data points (e.g., sample ambient data) to identify any inaccuracies or other errors.

If the output of the machine learning algorithm or artificial intelligence does not satisfy one or more criteria, the user monitoring system 106 may iteratively update one or more coefficients of the set of coefficients to generate an updated machine learning algorithm or artificial intelligence. For instance, the one or more criteria may include a threshold for the accuracy of the desired machine learning algorithm or artificial intelligence for converting ambient data into corresponding data segments and for classifying these data segments. The updated machine learning algorithm or artificial intelligence may be used to process the aforementioned training dataset, as well as any additional data points or other datasets obtained by the user monitoring gateway 102 to generate a new output for each data point in the training dataset. In some instances, the user monitoring system 106 may use an optimization algorithm to iteratively update the one or more coefficients of the set of coefficients associated with the machine learning algorithm or artificial intelligence. The user monitoring system 106 may use this updated machine learning algorithm or artificial intelligence to process the available data points and generate a new output. The user monitoring system 106 may evaluate this new output to determine whether the output satisfies the one or more criteria. This process of updating the set of coefficients associated with the machine learning algorithm or artificial intelligence according to the one or more criteria may be performed iteratively until an updated machine learning algorithm or artificial intelligence is produced that satisfies the one or more criteria.

In an embodiment, the user monitoring system 106 processes the data segments generated from the ambient data to generate event data that may be provided to different recipients according to any applicable user preferences and to the classifications of these data segments. The user monitoring gateway 102 may maintain separate and distinct modules or algorithms that may be used to process different data segments according to their assigned classifications. For instance, as noted above, certain data may be subject to different regulations, policies, or other restrictions on how this data may be processed, maintained, and disseminated to other entities. Accordingly, the user monitoring gateway 102, through the user monitoring system 106, may maintain different data processing modules that may be implemented to process different data segments according to any applicable regulations, policies, or other restrictions. For example, as described in greater detail herein, the user monitoring system 106 may implement distinct processing modules for processing of user data segments, health data segments, and device-specific data segments. Each of these processing modules may implement different algorithms, applications, and/or other processes for generating event data. As an illustrative example, the user monitoring system 106 may implement a health data processing module that is configured to process health-related data segments according to HIPAA and/or other regulatory requirements. At the same time, the user monitoring system 106 may implement a user data processing module that is configured to process user interaction data segments without need to comply with any regulations, policies, or other restrictions. Through this segmentation of the ambient data, the user monitoring system 106 increases the network security of the user monitoring gateway 102. For instance, because data segments generated from the ambient data are classified according to any applicable regulations, policies, and/or other restrictions, the user monitoring system 106 automatically prevents dissemination and processing of data segments in a manner that would violate these applicable regulations, policies, and/or other restrictions. For instance, health-related data segments that are subject to HIPAA and/or other regulatory requirements may be dynamically processed in a sandbox or other sterile computing environment whereby these data segments are not disseminated to any public entities or used publicly for training public-facing machine learning algorithms or artificial intelligence processes.

As the user monitoring system 106 generates event data corresponding to different user and/or user monitoring gateway events, the user monitoring system 106 may provide this event and/or user monitoring gateway data to an event data transmission module 108 implemented by the user monitoring gateway 102. The event data transmission module 108 may be implemented as an application or process executing on the user monitoring gateway 102 and is configured to process event data provided by the user monitoring system 106 to detect any possible user predictive anomalies that may denote one or more issues associated with the user and/or one or more devices and/or sensors 110 within the user environment. In some instances, the event data transmission module 108 may be implemented through various special-purpose components of the user monitoring gateway 102 that can facilitate real-time or near real-time processing of event data corresponding to different events to identify any user predictive anomalies and to notify one or more entities according to the types of user predictive anomalies detected and any user preferences.

A user predictive anomaly is an event that represents a deviation from a user's baseline or routine activities, behaviors, physiological state, or other attribute. For example, if a user is known to exhibit an average blood pressure of 130/90 mm Hg and a pulse of 145 beats per minute (bpm), a user predictive anomaly may be detected if the user's blood pressure and pulse increases significantly beyond these averages (e.g., 170/120 mm Hg and 205 bpm, etc.) without any other catalyst (e.g., the user is not engaged in a rigorous exercise, the user is sleeping, etc.). Further, a user predictive anomaly may be detected if these changes occur suddenly (e.g., within a minute, within a few seconds, etc.). As another illustrative example of a user predictive anomaly, if a user is associated with a known voice signature, a deviation from this known voice signature (such as if the user is slurring their words, having difficulty speaking, etc.) may represent a user predictive anomaly requiring additional evaluation. Thus, user predictive anomalies may represent motor control issues, cognitive issues, physical degradation, or other user physiological issues that may require additional attention.

In some instances, predictive anomalies may be associated with different devices and/or sensors 110 within the user environment and/or the user monitoring gateway 102 itself. For example, if the user environment includes a camera that continuously transmits audiovisual data to the user monitoring gateway 102 for processing, the absence of such audiovisual data over a period of time may represent a predictive anomaly that may correspond to an issue with the camera. As another illustrative example, if a blood glucose monitor transmits, to the user monitoring gateway 102, blood glucose readings that are highly variable (e.g., readings obtained over a few seconds show high variability, etc.), this high variability may represent a predictive anomaly that can be indicative of an issue with the blood glucose monitor or in the use of the blood glucose monitor by the user. In some instances, the user monitoring gateway 102 automatically generates device data specific to the user monitoring gateway 102 that may be used to determine the present operating state of the user monitoring gateway 102. As described in greater detail herein, the absence of such data may represent a predictive anomaly associated with the user monitoring gateway 102 that may be indicative of a particular issue affecting the performance of the user monitoring gateway 102.

In an embodiment, the event data transmission module 108 implements a machine learning algorithm or artificial intelligence that is dynamically trained to evaluate data corresponding to different events occurring within a user environment, as well as any external environment data (e.g., weather data, temperature data, barometric pressure data, humidity data, etc.), to detect any predictive anomalies associated with a user. This machine learning algorithm or artificial intelligence may be dynamically trained using supervised, unsupervised, or hybrid training techniques. For instance, a dataset of sample event data (e.g., historical data corresponding to previously detected events, hypothetical data corresponding to artificial events, combinations of historical and hypothetical data, etc.), sample user data (e.g., baseline information corresponding to known users, hypothetical baseline information for hypothetical users, combinations of actual and hypothetical baseline information, etc.), sample external environment data (e.g., historical external environment data, hypothetical external environment data, combinations of historical and hypothetical external environment data, etc.), and sample predictive anomalies corresponding to the sample event data and sample user data may be analyzed using the machine learning algorithm or artificial intelligence to identify any correlations amongst the sample predictive anomalies, the sample external environment data, and any deviations between the sample event data and the sample user data for each data point in the dataset. Based on these correlations, the machine learning algorithm or artificial intelligence may be dynamically trained to associate different deviations between event data and user data with particular types or categories of predictive anomalies. For instance, based on the type of event data obtained and the deviations between the event data and the user data, the machine learning algorithm or artificial intelligence may classify the event data according to one or more vectors of similarity between the event data and different types or categories of predictive anomalies.

Similar to the process for training the machine learning algorithm or artificial intelligence implemented by the user monitoring system 106, the event data transmission module 108 may generate an initial iteration of the machine learning algorithm or artificial intelligence to be used for identifying predictive anomalies from received event data. For instance, the event data transmission module 108 may initialize a set of coefficients {α1, α2, α3, . . . αn} randomly according to a Gaussian distribution or non-Gaussian distribution. Using this initial iteration of the machine learning algorithm or artificial intelligence, the event data transmission module 108 may process the dataset of sample event data to generate an output. This output may specify, for each data point corresponding to a particular set of event data, any identified predictive anomalies associated with a sample user and/or with sample sensors and/or devices within a user environment. The event data transmission module 108 may compare the output generated using the initial iteration of the machine learning algorithm or artificial intelligence to the sample vector values defined in the dataset for each of the data points (e.g., sample ambient data) to identify any inaccuracies or other errors. If the output of the machine learning algorithm or artificial intelligence does not satisfy one or more criteria, the event data transmission module 108 may iteratively update one or more coefficients of the set of coefficients to generate an updated machine learning algorithm or artificial intelligence. The updated machine learning algorithm or artificial intelligence may be used to process the aforementioned training dataset, as well as any additional data points or other datasets obtained by the user monitoring gateway 102 to generate a new output for each data point in the training dataset. The event data transmission module 108 may use this updated machine learning algorithm or artificial intelligence to process the available data points and generate a new output (e.g., new identifications of predictive anomalies based on the sample event data included in the dataset, etc.). The event data transmission module 108 may evaluate this new output to determine whether the output satisfies the one or more criteria. This process of updating the set of coefficients associated with the machine learning algorithm or artificial intelligence according to the one or more criteria may be performed iteratively until an updated machine learning algorithm or artificial intelligence is produced that satisfies the one or more criteria for identifying predictive anomalies from obtained event data.

In an embodiment, once the event data transmission module 108 has categorized the event data according to the identified predictive anomaly or, if no predictive anomaly was identified, according to the identified event classification, the event data transmission module 108 may determine how to route the event data to other entities. As noted above, event data may be transmitted to different event recipients 112 based on a set of preferences corresponding to the particular user associated with the event. Returning to an illustrative example described above, if the event data corresponds to a predictive anomaly that requires immediate medical attention (e.g., sudden changes to a user's blood pressure and/or pulse, detection of user losing consciousness, sudden slurring of speech, etc.), the event data transmission module 108 may evaluate the user preferences associated with the user and determine that the event data is to be transmitted to medical personnel which may be deployed to address the possible medical emergency. As another illustrative example, if the event data corresponds to a predictive anomaly associated with the user's eating habits (e.g., the user is exhibiting a loss of appetite, the user is experiencing stomach discomfort when eating, the user is regurgitating any ingested food, etc.), the event data transmission module 108 may evaluate the user preferences associated with the user and determine that, for this type of predictive anomaly, the event data is to be transmitted to a caregiver associated with the user. The caregiver may use this data to further evaluate the user to determine the cause of the predictive anomaly. By performing event data routing determinations according to the category of the identified event (e.g., type of predictive anomaly, absence of a predictive anomaly, etc.), the event data transmission module 108 may improve the functioning of the user monitoring gateway 102 by reducing the volume of event data transmissions to different entities to which corresponding event data may not be relevant or that otherwise may be unable to address a corresponding detected predictive anomaly.

In an embodiment, the event data transmission module 108 can transmit the event data to additional event recipients 112 if the event data transmission module 108 detects that the predictive anomaly has not been resolved within a pre-defined period of time. For example, if the event data transmission module 108 transmits the event data to a caregiver in response to detection of a predictive anomaly associated with a user, and the event data transmission module 108 later receives new event data that indicates that the predictive anomaly has not been resolved within the pre-defined period of time, the event data transmission module 108 may evaluate the set of preferences corresponding to the particular user to identify additional event recipients 112 (such as a doctor, emergency personnel, etc.) to which the original event data and the new event data may be transmitted in order to address the predictive anomaly. In some instances, the event data transmission module 108 may automatically identify one or more new event recipients 112 according to the classification or type of predictive anomaly that remains unresolved over the pre-defined period of time. For example, if the prolonged occurrence of a predictive anomaly serves as an indication or a severe medical issue associated with the particular user, the event data transmission module 108 may automatically transmit the event data to emergency medical personnel that may be able to address the predictive anomaly.

In an embodiment, the event data transmission module 108 can automatically generate different executable instructions or commands that may be transmitted to different devices and/or sensors 110 within the user environment in response to a predictive anomaly. As an illustrative example, if the event data transmission module 108 determines that event data corresponds to a predictive anomaly associated with a user's blood glucose levels, but the predictive anomaly does not rise to the level of requiring immediate medical attention, the event data transmission module 108 may transmit one or more executable instructions or commands to the user's blood glucose monitor to obtain additional blood glucose readings over a period of time. These additional blood glucose readings may be used to determine whether there is a possible issue with the user (e.g., change in diet resulting in higher blood glucose levels, medication not being taken, medication being ineffective, etc.) or with the blood glucose monitor itself (e.g., a malfunction resulting in inaccuracies, etc.). As another illustrative example, if the event data transmission module 108 determines that event data corresponds to a predictive anomaly associated with a user's body temperature and the event data transmission module 108 determines that the air conditioning system within the user environment is set to a high temperature, the event data transmission module 108 may automatically transmit executable instructions or other commands to the air conditioning system to lower the temperature within the user environment. Thus, the event data transmission module 108 may automatically communicate with the different devices and/or sensors 110 within the user environment to try and address any predictive anomalies that do not require immediate intervention (e.g., any events that do not represent an immediate health risk to the user, etc.). This may allow for autonomous root-cause identification and possible resolution of predictive anomalies without need for human intervention or transmission of data to human event recipients.

In an embodiment, the event data transmission module 108 further automatically transmits any device data associated with the user monitoring gateway 102 (e.g., telemetry data associated with the user monitoring gateway 102, data corresponding to different components of the user monitoring gateway 102, etc.) to a remote gateway health monitoring system 116. The gateway health monitoring system 116 may be implemented by a remote user monitoring service, which may provide user monitoring gateways to different users to monitor the health of these users and to perform the various functionalities described herein. The remote gateway health monitoring system 116 may continuously, in real-time or near real-time, evaluate received device data associated with the user monitoring gateway 102 to determine whether there are any issues impacting the performance of the user monitoring gateway 102. For instance, the gateway health data associated with the user monitoring gateway 102 may indicate any errors encountered by the user monitoring gateway 102 during operation (e.g., any software or hardware failure codes or indicators, communication errors associated with the different devices and sensors 110, battery capacity issues, firmware and/or software update or execution failures, detection of user tampering of the user monitoring gateway 102, etc.). Based on these identified errors, the gateway health monitoring system 116 may transmit the device data to one or more entities that may be able to address the identified errors associated with the user monitoring gateway 102 (e.g., technicians associated with the user monitoring service, the user, a caregiver associated with the user, etc.).

In an embodiment, the gateway health monitoring system 116 further monitors the user monitoring gateway 102 to automatically detect if the user monitoring gateway 102 is no longer transmitting gateway health data. For instance, the gateway health monitoring system 116 may initiate a timer corresponding to the amount of time since the gateway health monitoring system 116 has received gateway health data from the user monitoring gateway 102. If the gateway health monitoring system 116 receives new gateway health data from the user monitoring gateway 102, the gateway health monitoring system 116 may automatically reset the timer. However, if the gateway health monitoring system 116 does not receive any gateway health data from the user monitoring gateway 102, the timer may continue to automatically increment, denoting the time since gateway health data was received.

In an embodiment, if the gateway health monitoring system 116 determines that the timer has expired (e.g., a maximum amount of time has elapsed since new gateway health data was received, a maximum amount of time has elapsed since the timer was reset, etc.), the gateway health monitoring system 116 generates one or more synthetic events that may denote possible issues with the user monitoring gateway 102. For instance, the lack of gateway health data from the user monitoring gateway 102 may represent one or more possible issues related to the performance of the user monitoring gateway 102. For example, the lack of gateway health data may represent a failure of the hardware and/or software of the user monitoring gateway 102. As another illustrative example, the lack of gateway health data may represent power-related issues, such a power outage within the user environment, a battery or other power supply failure, and the like. The synthetic events generated by the gateway health monitoring system 116 may include an indication of the last time that gateway health data was received by the gateway health monitoring system 116 from the user monitoring gateway 102 (e.g., a timestamp corresponding to the most recently received gateway health data, etc.). Additionally, the synthetic events may include one or more portions of the previously obtained gateway health data up to the most recently received gateway health data. This may help a recipient of the synthetic events to review these portions of the previously obtained gateway health data for diagnostic and/or troubleshooting purposes (e.g., identifying the root cause of the lack of new gateway health data, etc.).

The gateway health monitoring system 116, in some instances, may transmit the synthetic events associated with a lack of gateway health data to one or more entities to address any possible issues associated with the user monitoring gateway 102. For instance, the gateway health monitoring system 116 may transmit the synthetic event to one or more technicians trained to service user monitoring gateways and address any issues that may impact performance of these user monitoring gateways. As another illustrative example, the gateway health monitoring system 116 may transmit the synthetic events to the user or other entity associated with the user (e.g., medical personnel, a caregiver, etc.) to troubleshoot any issues associated with the user monitoring gateway 102 and provide any additional information to the gateway health monitoring system 116 in the event that these issues cannot be resolved by the user or other entity.

In an embodiment, the gateway health monitoring system 116 can escalate different synthetic events corresponding to the user monitoring gateway 102 as the period of time since the timer has expired continues to elapse. For example, when the aforementioned timer first expires, the gateway health monitoring system 116 may initially transmit the synthetic events associated with the user monitoring gateway 102 to the user or to another entity associated with the user and that has access to the user monitoring gateway 102 (e.g., medical personnel, a caregiver, etc.). If the gateway health monitoring system 116 continues to receive no new gateway health data from the user monitoring gateway 102, the gateway health monitoring system 116 may transmit the synthetic events and/or new synthetic events corresponding to the continued lack of gateway health data to one or more technicians that may be dispatched to the user environment to inspect the user monitoring gateway 102 and address any identified issues associated with the user monitoring gateway 102.

In some instances, the gateway health data may include data corresponding to communications between the user monitoring gateway 102 and the different devices and sensors 110 within the user environment. For example, the gateway health data may include timestamps corresponding to communications exchanged between the different devices and sensors 110 within the user environment and the user monitoring gateway 102. In an embodiment, the gateway health monitoring system 116 can evaluate the gateway health data from the user monitoring gateway 102 using the aforementioned timer to dynamically detect any lack of communications between the user monitoring gateway 102 and one or more devices and/or sensors within the user environment which may denote an issue with the user monitoring gateway 102 and/or these one or more devices and/or sensors. Further, based on which devices and/or sensors are impacted, the gateway health monitoring system 116 may automatically generate device/sensor-specific synthetic events that may be transmitted to one or more entities that may be able to address any issues associated with the connections between the user monitoring gateway 102 and the one or more devices and/or sensors.

In an embodiment, the user monitoring gateway 102 updates the myriad machine learning algorithms or artificial intelligence used to detect different events within the user environment, perform data segmentation and classification of ambient data, and to identify predictive anomalies associated with these different events based on feedback from different entities. For example, if the event data transmission module 108, through the machine learning algorithm or artificial intelligence trained to detect predictive anomalies from obtained event data, fails to detect a particular predictive anomaly associated with the user, the user monitoring gateway 102 may update the dataset used to train the machine learning algorithm or artificial intelligence implemented by the event data transmission module 108 to add a data point that indicates, for the particular event data from which the predictive anomaly was missed, the predictive anomaly that should have been detected. The updated training dataset may be used to evaluate the performance of the machine learning algorithm or artificial intelligence and, accordingly, generate a new iteration of the machine learning algorithm or artificial intelligence that more accurate detects predictive anomalies from provided event data. As another illustrative example, if the user monitoring system 106, through the machine learning algorithm or artificial intelligence trained to segment ambient data according to different classifications, assigns an incorrect classification to a particular data segment (e.g., device data classified as being user interaction data, etc.), the user monitoring gateway 102 may update the training dataset for this particular machine learning algorithm or artificial intelligence to annotate the data segment with the correct or expected classification. The user monitoring gateway 102, through the user monitoring system 106, may process the updated training dataset through the machine learning algorithm or artificial intelligence to obtain an output. Based on this output, the user monitoring gateway 102 may update one or more coefficients of the machine learning algorithm or artificial intelligence to generate a new iteration of the machine learning algorithm or artificial intelligence that may be evaluated. This iterative process may continue until an iteration of the machine learning algorithm or artificial intelligence is generated that satisfies one or more criteria. Thus, as ambient data is obtained and segmented according to different classifications for the detection of predictive anomalies in real-time or near real-time, the various machine learning algorithms or artificial intelligence described herein are continuously updated to better detect events occurring within the user environment, segment and classify ambient data, and correctly identify any predictive anomalies that may necessitate action from one or more entities.

It should be noted that the user monitoring gateway 102, through the aforementioned components and corresponding machine learning algorithms or artificial intelligence, can continuously and simultaneously process ambient data from the myriad devices and sensors within the user environment, as well as external environment data (e.g., weather data, temperature data, barometric pressure data, humidity data, etc.), to detect, in real-time or near real-time, any events and classify the data associated with these events to allow for processing of the data subject to any known requirements. Further, the user monitoring gateway 102, through the aforementioned components and corresponding machine learning algorithms or artificial intelligence, can continuously and simultaneously process the classified data to identify any predictive anomalies that may be indicative of user issues within the user environment requiring attention from other entities (e.g., medical personnel, a caregiver, etc.). For instance, as different ambient data associated with different devices and/or sensors within different portions of the user environment is obtained, the user monitoring gateway 102, through the aforementioned components and corresponding machine learning algorithms or artificial intelligence, may simultaneously process this ambient data from these different devices and/or sensors to detect any number of simultaneously occurring events within the user environment, classify the data corresponding to these events, and evaluate the data corresponding to these simultaneously occurring events to identify any predictive anomalies occurring within the user environment.

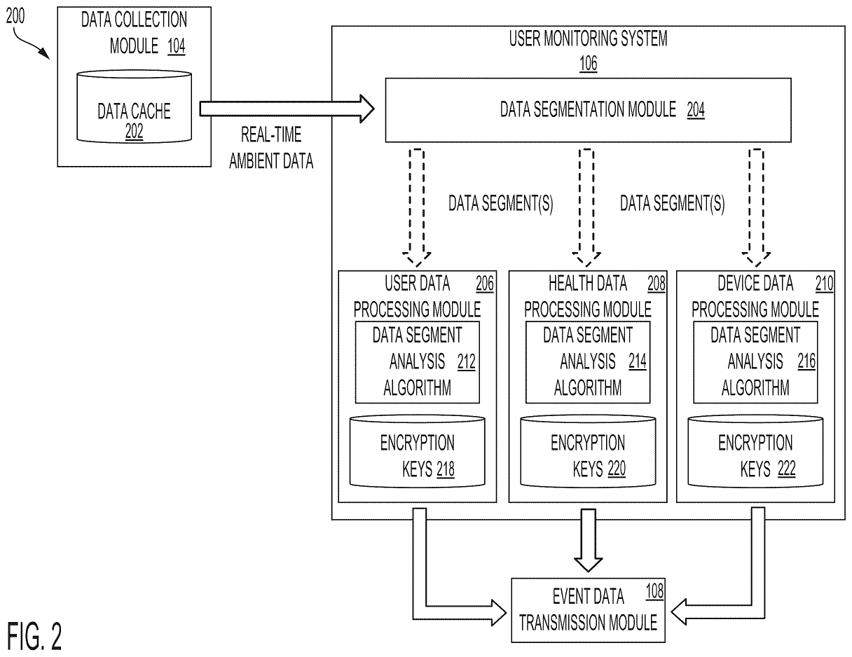

FIG. 2 shows an illustrative example of an environment 200 in which a user monitoring system 106 of the user monitoring gateway performs segmentation of real-time ambient data according to different regulatory and policy requirements in accordance with at least one embodiment. In the environment 200, the user monitoring system 106 implements a data segmentation module 204 configured to obtain real-time ambient data collected from myriad devices and sensors within a user environment to generate data segments according to different categories. The data segmentation module 204 may comprise one or more computer systems of the user monitoring system 106 or may be implemented as an application or process executing on a computer system of the user monitoring system 106. In some instances, the data segmentation module 204 may be configured with various special-purpose components that can facilitate real-time or near real-time processing of ambient data as the ambient data is received.

In an embodiment, the data segmentation module 204 obtains real-time ambient data from a data cache 202 maintained by the data collection module 104. As noted above, the data collection module 104 implements a data cache 202 that is configured to store real-time ambient data for a limited period of time or based on data heuristics. For example, the data collection module 104 may implement a timer that may be used to define the amount of time ambient data may be stored in the data cache before the ambient data is automatically transmitted to the data segmentation module 204 for categorization and dissemination of the ambient data to different recipients. Additionally, or alternatively, the data collection module 104 may automatically transmit real-time ambient data from the data cache to the data segmentation module 204 in response to a triggering event. Returning to an earlier illustrative example, the data collection module 104, through a trained machine learning algorithm or artificial intelligence, may process real-time ambient data to detect any events occurring within the user environment according to received ambient data and/or the lack of ambient data over a period of time. If the data collection module 104 detects that an event requiring immediate attention has occurred or is ongoing, the data collection module 104 may automatically transmit this ambient data from the data cache 202 to the data segmentation module 204 for further processing. Thus, for events requiring immediate attention, the data collection module 104 may forego a timer-based trigger and, in real-time or near real-time, transmit this data from the data cache 202 to the data segmentation module 204. If the data collection module 104 determines, through processing of the ambient data, that an event does not require immediate attention, the data collection module 104 may maintain the ambient data associated with the particular event in the data cache 202 subject to a timer-based trigger. The timer-based trigger, as noted above, may represent a limited period of time for which ambient data corresponding to an event may be stored in the data cache 202 before the ambient data may be automatically transmitted to the data segmentation module 204 for further processing.

In an embodiment, the data segmentation module 204 dynamically processes the ambient data from the data cache 202 to generate different data segments according to different data classifications or categories. As noted above, certain ambient data from the user environment may be subject to different regulations, policies, or other restrictions that may impact how this data may be processed, maintained, and disseminated to other entities. The data segmentation module 204, in an embodiment, implements a machine learning algorithm or artificial intelligence that is dynamically trained to perform data segmentation of the ambient data from the data cache 202 to generate distinct data segments according to different classifications or categories. The different classifications or categories may be defined according to the different regulations, policies, or other restrictions that are applicable to different types of data generated by the different devices and sensors within the user environment. For example, any data including PII or PHI of a user may be subject to HIPAA or other privacy-related regulations whereby additional safeguards may be required to prevent unauthorized dissemination of such data to unauthorized entities. Alternatively, data related to the performance of these devices and sensors, as well as of the user monitoring gateway itself, may not be subject to such regulations and thus may be evaluated without any additional safeguards.

As illustrated in FIG. 2, the user monitoring system 106 may implement distinct processing modules according to the different classifications or categories that may be assigned to different data segments. For example, the user monitoring system 106 may maintain a user data processing module 206 that is configured to dynamically process data segments including user-related data (e.g., data segments classified as containing user data) to generate event data corresponding to a detected event. Further, the user monitoring system 106 may maintain a health data processing module 208 that is configured to dynamically process health-related data corresponding to different users within the user environment for the creation of event data corresponding to a detected event. The user monitoring system 106 may further implement a device data processing module 210 that is configured to process data segments containing device-specific data corresponding to the performance of devices and sensors within the user environment and to the performance of the user monitoring gateway. It should be noted that the processing modules 206-210 illustrated in FIG. 2 are provided for the purpose of illustration and additional and/or alternative processing modules may be implemented by the user monitoring system 106 according to the different classifications or categories that may be assigned to different data segments generated by the data segmentation module 204. For instance, the user monitoring system 106 may implement a number of distinct processing modules according to the number of different regulations, policies, or other restrictions that may be applicable to ambient data from the myriad devices and sensors in the user environment. In some instances, the number of distinct processing modules may correspond to the number of different data processing requirements defined according to the different applicable regulations, policies, or other restrictions.

In an embodiment, the different data processing modules 206-210 are maintained in isolation from one another in order to prevent intermingling of different types of data segments from the data segmentation module 204. For example, in an embodiment, the user monitoring system 106 includes a set of software containers that may execute in isolation from each other (e.g., a software container may have an isolated view of a file system, etc.). For instance, the user data processing module 206, the health data processing module 208, and the device data processing module 210 may be executed on distinct software containers that are isolated from other processes operating within the user monitoring system 106. In some instances, the user monitoring system 106, for each data processing module 206-210, may implement a software container that serves as a storage volume for data segments and event data, a software container that provides resources for implementing and operating a data segment analysis algorithm (as described in greater detail herein), a software container that provides a storage volume for cryptographic keys, a software container for encrypting new event data according to any applicable regulations, policies, or other restrictions, and the like. The software container used to implement a data processing module may be configured to only have limited access to resources available via other software containers of the user monitoring system 106. Thus, the software container may be executed to have access to only certain resources from the computing resources allocated for the particular data processing module. Due to this isolation, each data processing module 206-210 may only be able to access certain resources allocated to each data processing module 206-210 by the user monitoring system 106. This may prevent inadvertent exposure and processing of data that may be subject to more stringent regulations, policies, or other restrictions using the same resources as those used to process data that is not subject to such regulations, policies, or other restrictions.

In an embodiment, each of the data processing modules 206-210 implements a data segment analysis algorithm 212-216, respectively, that is dynamically trained to process their respective data segments according to any applicable regulations, policies, or other restrictions. For example, the data segment analysis algorithm 212 implemented by the user data processing module 206 may be dynamically trained to process data segments classified as including user interaction data (e.g., user inputs to different devices and sensors within the user environment, any timeout events corresponding to expected user interactions with devices and sensors, any detected latency in user interactions, etc.) to generate event data corresponding to user interactions with different devices and sensors within the user environment. User interaction data, in some instances, may not be subject to any regulations, policies, or other restrictions and, thus, may be processed without implementation of additional controls to prevent inadvertent exposure of this data. As another illustrative example, the data segment analysis algorithm 216 implemented by the device data processing module 210 may be dynamically trained to process data segments classified as including device-specific and/or sensor-specific data associated with the myriad devices and sensors within the user environment and the user monitoring gateway itself. Thus, this data, similarly, may not be subject to any regulations, policies, or other restrictions. As a result of data segments classified or categorized as including user interaction data or device/sensor-specific data not being subject to such regulations, policies, or other restrictions, the data segment analysis algorithms 212, 216 implemented to process these data segments may be updated or otherwise adjusted without having to go through any certification processes, allowing for more regular retraining through common mechanisms (e.g., Over-the-Air (OTA) updates, publicly available datasets, etc.).

Alternatively, the data segment analysis algorithm 214 implemented by the health data processing module 208 may be dynamically trained to process data segments classified as including health-related data corresponding to users in the user environment (e.g., PHI, user health metrics, etc.) and that may be subject to more stringent regulations, policies, or other restrictions. The data segment analysis algorithm 214, thus, may be required to be trained in compliance with these more stringent regulations, policies, or other restrictions to prevent inadvertent exposure of user health data to unauthorized entities and to ensure that the user health data is not used for other purposes (e.g., training of the data segment analysis algorithm 214, inclusion in datasets used to train other algorithms, etc.) without anonymization or other process to prevent such user health data being linked to the user from which it was derived. Accordingly, the data segment analysis algorithm 214 implemented by the health data processing module 208 may require additional certification processes in order to be implemented and whenever any updates are made to the health data processing module 208.

In an embodiment, each data processing module 206-210 further implements an encryption key datastore 218-222 that may be used to persist any cryptographic keys required for encryption of event data subject to different regulations, policies, or other restrictions. In some instances, in order to prevent inadvertent exposure of data subject to particular regulations, policies, or other restrictions, any data generated by a corresponding data processing module may require particular safeguards or other controls. These safeguards or other controls may include the implementation of particular cryptographic methods to provide an adequate level of security with regard to data processed and disseminated by the corresponding data processing module. As different data processing modules 206-210 may be subject to different regulations, policies, or other restrictions, the cryptographic methods implemented by these data processing modules 206-210 may differ. Thus, the encryption key datastore 218-222 implemented by the different data processing modules 206-210, respectively, may implement different types of cryptographic keys for encrypting any data produced by these different data processing modules 206-210. In some instances, if certain data is not subject to any regulations, policies, or other restrictions, the corresponding data processing module may not include an encryption key datastore as the data may be provided in a plain (i.e., unencrypted) format.

In an embodiment, each data processing module 206-210, through their respective data segment analysis algorithms 212-216, processes the data segments generated from the ambient data to generate event data that may be provided to different recipients according to any applicable user preferences and to the classifications of these data segments. Event data generated by a particular data processing module may include metadata denoting the classification or category of the ambient data that was processed to generate the event data. Additionally, the metadata may denote an identifier or other indicator of the type of event detected and associated with the event data (as defined by the data collection module 104). This may allow for collection of event data corresponding to a particular type of event without exposing or mingling of any of the underlying data. For instance, encrypted health data corresponding to a particular event may be collected with unencrypted user interaction data corresponding to the particular event without need to decrypt the encrypted health data. As the user monitoring system 106, through the data processing modules 206-210, generates event data corresponding to different user and/or user monitoring gateway events, the user monitoring system 106 may provide this event and/or user monitoring gateway data to an event data transmission module 108 for dissemination to different entities according to any applicable user preferences and/or user monitoring gateway settings.

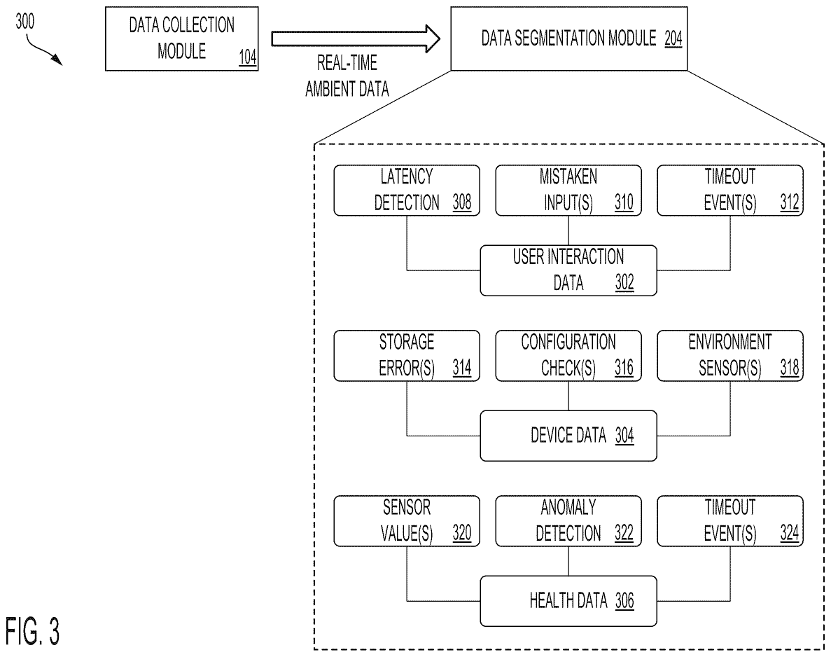

FIG. 3 shows an illustrative example of an environment 300 in which a data segmentation module 204 implemented by the user monitoring gateway performs segmentation of real-time ambient data according to the different types or categories of data included in the real-time ambient data in accordance with at least one embodiment. As noted above, the data segmentation module 204 is configured to dynamically process real-time ambient data from myriad devices and sensors within the user environment (including the user monitoring gateway) to generate and classify/categorize different data segments for further processing subject to any applicable regulations, policies, or other restrictions. The data segmentation module 204 may implement and dynamically train a classification algorithm to divide the ambient data into distinct data segments according to different classifications of the ambient data. This machine learning algorithm or artificial intelligence may be dynamically trained using supervised, unsupervised, or hybrid training techniques. For instance, a dataset of sample ambient data and sample data classifications according to different data attributes may be generated for training of the machine learning algorithm or artificial intelligence. These different data attributes may include, for example and as illustrated in FIG. 3, user interaction data 302, device data 304, and user health data 306. However, it should be noted that the machine learning algorithm or artificial intelligence implemented by the data segmentation module 204 may maintain additional and/or alternative data attributes that may serve as possible classifications or categorizations for different data segments generated by the data segmentation module 204. These additional and/or alternative data attributes may be defined according to any regulations, policies, or other restrictions that may be applicable to different types of data collected and processed by the user monitoring gateway.

As noted above, in some instances, the dataset used to dynamically train the machine learning algorithm or artificial intelligence implemented by the data segmentation module 204 may further include additional data classifications that may serve as indications as to whether data is regulated (i.e., subject to one or more regulations, policies, or other restrictions) or unregulated. For example, data that is classified as being user health data 306 may also be classified as being regulated and, thus, requiring separate processing and handling by the user monitoring gateway. As another illustrative example, data that is classified as being device data 304 may also be classified as being unregulated data such that this data can be processed through any available methods implemented by the user monitoring gateway. Thus, the machine learning algorithm or artificial intelligence implemented by the data segmentation module 204 may be dynamically trained to perform an initial classification of the ambient data according to the data attributes of the ambient data for segmentation and, subsequently, perform a second classification of the individual data segments according to the types of initial classifications assigned to the individual data segments.

To dynamically train the machine learning algorithm or artificial intelligence implemented by the data segmentation module 204, the data segmentation module 204 may generate an initial iteration of the machine learning algorithm or artificial intelligence. For instance, the data segmentation module 204 may initialize a set of coefficients {α1, α2, α3, . . . αn} randomly according to a Gaussian distribution or non-Gaussian distribution. Using this initial iteration of the machine learning algorithm or artificial intelligence, the data segmentation module 204 may process the dataset of sample ambient data to generate an output. This output may specify, for each data point corresponding to a particular set of ambient data, a set of data segments and corresponding classifications for the set of data segments. The data segmentation module 204 may compare the output generated using the initial iteration of the machine learning algorithm or artificial intelligence to the sample data segments and corresponding classifications defined in the dataset for each of the data points (e.g., sample ambient data) to identify any inaccuracies or other errors. It should be noted that, in some instances, this initial iteration of the machine learning algorithm or artificial intelligence may be implemented using anonymized ambient data such that no reference to actual users is provided through the dataset of sample ambient data.

If the output of the machine learning algorithm or artificial intelligence does not satisfy one or more criteria, the data segmentation module 204 may iteratively update one or more coefficients of the set of coefficients to generate an updated machine learning algorithm or artificial intelligence. The updated machine learning algorithm or artificial intelligence may be used to process the aforementioned training dataset, as well as any additional data points or other datasets obtained by the user monitoring gateway to generate a new output for each data point in the training dataset. The data segmentation module 204 may use this updated machine learning algorithm or artificial intelligence to process the available data points and generate a new output. The data segmentation module 204 may evaluate this new output to determine whether the output satisfies the one or more criteria. This process of updating the set of coefficients associated with the machine learning algorithm or artificial intelligence according to the one or more criteria may be performed iteratively until an updated machine learning algorithm or artificial intelligence is produced that satisfies the one or more criteria.

As illustrated in FIG. 3, the different data classifications or categories may correspond to different types of ambient data collected from the user environment. For example, user interaction data 302 may include any latency detection data 308 corresponding to user delays in interacting with one or more sensors and/or devices within the user environment. Further, latency detection data 308 may include synthetic data corresponding to gaps in user interactions with particular sensors and/or devices within the user environment. For example, if a particular device prompts a user to provide an input and the user does not provide an input in response to this prompting, the particular device may automatically generate synthetic data corresponding to the user's failure to provide an input. In some instances, the latency detection data 308 may indicate the amount of time between the user being prompted to provide an input or to otherwise perform an action and the user actually providing the requested input or performing the requested action.

The user interaction data 302 may further include any mistaken input data 310. Mistaken input data 310 may include data corresponding to any user deviations from a particular or expected input, as detected through one or more sensors and/or devices within the user environment. For example, if a particular device within the user environment prompts the user to select a particular button to initiate a blood pressure reading, but the user selects a different button or the device detects that the user has missed the button altogether, the device may generate data indicative of the user's mistaken input to the device. As this form of data may correspond to user interactions with different devices and sensors within the user environment, mistaken input data 310 may be classified or categorized as user interaction data 302. In some instances, the mistaken input data 310 may further include any failures to provide any input to one or more devices. Returning to the earlier illustrative example where a device prompts the user to select a button to initiate a blood pressure reading, the device may detect if the user fails to provide any input to the device within a period of time. Accordingly, the device may generate data indicative of the user's failure to provide any input in response to the prompt. This absence of user input may be further classified or categorized as user interaction data 302 usable to detect predictive anomalies.

In some instances, certain timeout events 312 may be classified or categorized as user interaction data 302. Returning to an earlier illustrative example, where a particular device within the user environment prompts the user to provide an input, if the user does not provide the requested input or any other input within a pre-defined period of time, the particular device may automatically generate synthetic data to indicate that the user has failed to provide an input within the pre-defined time and, thus, a timeout event has occurred. In some instances, the data collection module 104 rather than the particular device may generate the synthetic timeout event. For example, the data collection module 104 may implement a timer for each device and sensor within the user environment that may be used to track user interaction data from these devices and sensors. If the timer corresponding to a particular device or sensor expires (e.g., a maximum amount of time has elapsed since the last received user interaction data), the data collection module 104 may automatically generate synthetic data indicating that no user interaction data has been received over a pre-defined period of time and, thus, a timeout event 312 has occurred. Thus, the lack of user interaction with different devices and sensors within the user environment may be classified as user interaction data 302.

Device data 304 may include storage error data 314 corresponding to the user monitoring gateway and/or any of the devices and sensors implemented in the user environment. For example, if a device or sensor within the user environment encounters a storage error when capturing data or inputs within the user environment, the device or sensor may automatically generate storage error data 314 indicating an issue corresponding to the storage of data or inputs within the user environment. Storage errors may correspond to device or sensor hardware failures at the point of contact (e.g., memory or storage device errors) that prevent storage of data/inputs from the user environment. Further, storage errors may correspond to device or sensor firmware/software failures that may impact access to different storage devices of the device or sensor resulting in an inability to properly store data/inputs from the user environment. In some instances, storage errors may correspond to other events within the user environment impacting performance of the device or sensor, such as power-related issues (e.g., low battery, power failures, etc.), user intervention (e.g., user tampering with storage devices, user selecting an option to power down the device or sensor, etc.), and the like.

Device data 304 may further include data corresponding to configuration checks 316 performed by the user monitoring gateway and/or any of the devices and sensors implemented in the user environment. For example, the user monitoring gateway and the devices and sensors implemented in the user environment may periodically perform different configuration checks to ensure that they are operating normally and to detect any issues that may be impacting performance. Further, in some instances, the user monitoring gateway and the devices and sensors may automatically perform different configuration checks in response to a triggering event. For example, when a device or sensor is powered on, the device or sensor may automatically perform one or more configuration checks to ensure that the device or sensor is operating normally. In some instances, a device or sensor may automatically perform one or more configuration checks in response to any modification or tampering of the device or sensor (e.g., a user installs new hardware and/or software on the device or sensor, a user has modified one or more pre-defined settings associated with the device or sensor, etc.). Through these configuration checks, the user monitoring gateway and the devices/sensors implemented in the user environment may generate data that includes different configuration and performance metrics that may be used to detect any performance issues related to the user monitoring gateway and/or the devices/sensors.

In some instances, the device data 304 may further include environment sensor data 318 that may provide further insight into the operation of different devices and sensors in the user environment. For example, a device or sensor within the user environment may include an internal thermal sensor that may be used to detect the internal temperature of the device or sensor. The device or sensor may continuously transmit data generated through this internal thermal sensor to indicate the internal temperature of the device or sensor, as the internal temperature may be used to detect any overheating issues. As another illustrative example, a device or sensor may include an air quality sensor that may monitor certain air quality metrics (e.g., particle pollution levels, carbon monoxide levels, ozone levels, sulfur dioxide levels, nitrogen dioxide levels, allergen levels, etc.) that may have an impact on users and/or the performance of the device or sensor. This environment sensor data 318 may be transmitted periodically or in response to a triggering event (e.g., spikes in one or more air quality metrics, etc.) to the data collection module 104 and classified as device data 304 by the data segmentation module 204. Other environmental sensor data 318 may include data corresponding to sounds, vibrations, humidity, and any other environmental factors that may denote the presence of predictive anomalies or that otherwise may have an impact on users and/or the performance of corresponding devices and/or sensors.

As noted above, the data segmentation module 204 may further classify certain data as including health data 306 associated with one or more users within the user environment. Health data 306 may be subject to different regulations, policies, or other restrictions on how this data may be processed, maintained, and disseminated to other entities. Thus, the data segmentation module 204 may be configured to distinguish and isolate health data 306 from other forms of data that may be processed without additional controls and that are not subject to these different regulations, policies, or other restrictions. As illustrated in FIG. 3, health data 306 may include sensor value data 320 associated with different devices or sensors implemented in the user environment. This sensor value data 320 may correspond to data collected from particular types of devices or sensors including, but not limited to, personal fitness tracking devices, smartphones, smart watches, tablet computing devices, smart eyewear, augmented reality devices, wearable medical devices (e.g., glucose level monitors, blood pressure monitors, personal thermometers, electrocardiogram monitors, pacemakers, etc.), biosensors, and other devices or sensors that may be configured to dynamically collect personal health data associated with the user utilizing these devices or sensors.

In some instances, these different devices or sensors may be configured to automatically process any personal health data associated with a user to detect any anomalies that may be indicative of a health issue. For example, a blood pressure monitor that continuously monitors a user's blood pressure may dynamically detect a spike in the user's blood pressure. Accordingly, this blood pressure monitor may dynamically generate anomaly detection data 322 indicating this spike in the user's blood pressure. As another illustrative example, a pacemaker that detects a user's irregular heartbeat may be triggered to restore the user's cardiac rhythm. This triggering of the pacemaker may be recorded as anomaly detection data 322 and transmitted to the data collection module 104. As this anomaly detection data 322 may correspond to a user-specific health issue, this anomaly detection data 322 may be subject to different regulations, policies, or other restrictions. Thus, such anomaly detection data 322 may be classified as health data 306 by the data segmentation module 204.

In addition to sensor value data 320 and anomaly detection data 322, certain timeout events 324 may be classified or categorized as health data 306. For instance, if a wearable medical device is unable to obtain a personal reading from a user (e.g., a blood glucose level reading, a blood pressure reading, a heartrate, etc.) over a pre-defined period of time, the wearable medical device may automatically generate synthetic data denoting the absence of data associated with the user for the particular health metric over this pre-defined period of time. This synthetic data may be classified as a timeout event 324 specifically associated with the user and for a health-related metric. Thus, such timeout events 324 may denote a health issue that is subject to different regulations, policies, or other restrictions, requiring its classification as health data 306.

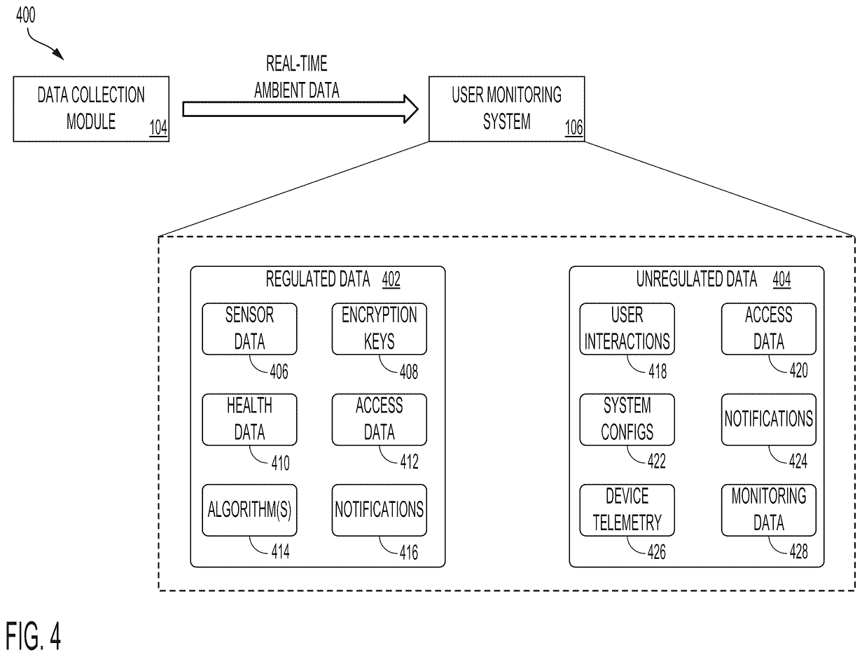

FIG. 4 shows an illustrative example of an environment 400 in which a user monitoring system 106 implemented by a user monitoring gateway separates real-time ambient data into regulated data 402 and unregulated data 404 in accordance with at least one embodiment. As noted above, the user monitoring system 106 may implement a machine learning algorithm or artificial intelligence that is dynamically trained to parse real-time ambient data into regulated and unregulated data. For example, the dataset used to dynamically train the machine learning algorithm or artificial intelligence implemented by the user monitoring system 106 may include data classifications that may serve as indications as to whether data is regulated (i.e., subject to one or more regulations, policies, or other restrictions) or unregulated. For instance, data that is classified as being user health data may also be classified as being regulated and, thus, requiring separate processing and handling by the user monitoring gateway. As another illustrative example, data that is classified as being device data may also be classified as being unregulated data such that this data can be processed through any available methods implemented by the user monitoring gateway. Thus, the machine learning algorithm or artificial intelligence implemented by the user monitoring system 106 may be dynamically trained to perform an initial classification of the ambient data according to the data attributes of the ambient data for segmentation and, subsequently, perform a second classification of the individual data segments according to the types of initial classifications assigned to the individual data segments.

As illustrated in FIG. 4, regulated data 402 may include certain sensor data 406 that may be subject to one or more regulations, policies, or other restrictions. For example, certain sensors within a user environment may collect data that may be used to generate a user profile associated with a particular user within the user environment. For instance, sensor data 406 may include information corresponding to user habits within the user environment (e.g., sleep patterns, hygiene activities, eating habits, etc.). Further, the sensor data 406 may include information corresponding to different user preferences (e.g., brands of choice, interactions with different forms of media, music preferences, viewing preferences, etc.). This sensor data 406, in some instances, may be used for user profiling and could feasibly be used to target the user with certain unsolicited advertisements, promotions, offers, and the like. Further, this sensor data 406, to some users, may include information that the user would prefer to remain private. Such sensor data 406, thus, may be subject to certain privacy-related regulations, policies, or other restrictions whereby the sensor data 406 may not be exposed to any unauthorized entities without affirmative user consent.

Regulated data 402 may further include any encryption keys 408 maintained by the user monitoring gateway for encrypting any data that is to be disseminated to authorized entities. As noted above, in order to prevent inadvertent exposure of data subject to particular regulations, policies, or other restrictions, any data generated by the user monitoring system 106 through a data processing module may require particular safeguards or other controls. These safeguards or other controls may include the implementation of different cryptographic methods to provide an adequate level of security with regard to data processed and disseminated by the user monitoring system 106. As different data processing modules implemented by the user monitoring system 106 may be subject to different regulations, policies, or other restrictions, the cryptographic methods implemented by these data processing modules may also differ. However, the different encryption keys 408 implemented for encrypting any data produced by these different data processing modules may be regulated in order to prevent exposure of these encryption keys 408 to unauthorized entities, which may lead to exposure of other sensitive data.

As noted above, any health data 410 associated with different users in the user environment may be classified as regulated data 402. Health data 410 may include, for instance, data corresponding to user health metrics (e.g., pulse, oxygen levels, blood pressure, etc.), PHI associated with the different users in the user environment, and the like. Health data 410 may be subject to certain regulations, policies, and/or restrictions such as HIPAA compliance requirements, FDA policies and certification requirements, and the like.

Certain access data 412 may be classified as regulated data 402 by the user monitoring system 106. For instance, access data 412 that includes any user credentials (e.g., passwords, cryptographic tokens, cryptographic keys, etc.) for accessing different devices and sensors within the user environment (including the user monitoring gateway) may be regulated to prevent inadvertent exposure of these user credentials to unauthorized entities. Access data 412 may further include user credentials for accessing other external resources, such as any websites or other resources associated with the different devices and/or sensors implemented in the user environment. Such access data 412 may be classified as being regulated data 402 to prevent exposure of this access data 412 to unauthorized entities that may use the access data 412 to gain access to the different devices and sensors within the user environment.

The different machine learning algorithms 414 implemented by the user monitoring gateway may be classified as being regulated data 402 by the user monitoring system 106 to prevent exposure of these different machine learning algorithms 414 to unauthorized entities. As these different machine learning algorithms 414 may dynamically process different regulated and unregulated data to generate different event data associated with different users in the user environment, these different machine learning algorithms 414 may require additional controls to prevent exposure of any data being processed. Further, certain machine learning algorithms 414 that process other regulated data 402 may be required to be trained in compliance with more stringent regulations, policies, or other restrictions to prevent inadvertent exposure of data to unauthorized entities and to ensure that the data is not used for other purposes (e.g., training of the machine learning algorithms, inclusion in datasets used to train other algorithms, etc.) without anonymization or other process to prevent such data being linked to the user from which it was derived. Accordingly, these machine learning algorithms 414 may require additional certification processes in order to be implemented and whenever any updates are made to these algorithms 414.

In some instances, certain notifications 416 for other entities may be classified as regulated data 402 requiring separate handling by the user monitoring gateway. For example, certain notifications 416 may include PII, PHI, and/or other sensitive information associated with the user and that may be subject to different regulations, policies, and/or restrictions. These notifications 416, for instance, may be subject to one or more encryption requirements whereby these notifications 416 are to be encrypted according to the one or more encryption requirements (e.g., approved encryption methods, algorithms, etc.) to prevent inadvertent exposure of plain-text data to any unauthorized entities. As these notifications 416 may require specialized encryption according to the aforementioned encryption requirements (including the use of encryption keys 408), these notifications 416 may need to be processed and disseminated to authorized entities as regulated data 402 through isolated modules (e.g., software containers, etc.).

The user monitoring system 106, as illustrated in FIG. 4, may further parse certain real-time ambient data into unregulated data 404 that may not be subject to any regulations, policies, and/or restrictions that dictate how data may be processed and disseminated by the user monitoring gateway. Unregulated data 404 may include, for instance, user interaction data 418 corresponding to any user interactions with different devices and sensors within the user environment. This user interaction data 418 may include latency detection data corresponding to user delays in interacting with one or more sensors and/or devices within the user environment. Further, this latency detection data may include synthetic data corresponding to gaps in user interactions with particular sensors and/or devices within the user environment. The user interaction data 418 may further include any mistaken input data. As noted above, mistaken input data may include data corresponding to any user deviations from a particular or expected input, as detected through one or more sensors and/or devices within the user environment. Additionally, the user interaction data 418 may include certain timeout events, including synthetic data that provides an indication user failures to provide a requested input within a pre-defined time.

Certain access data 420 may also be classified as being unregulated data 404. For example, access data corresponding to different devices and sensors in the user environment that does include any PII, PHI, or other sensitive user information may not be subject to any regulations, policies, and/or restrictions as opposed to the access data 412 described above. The access data 420 may include, for instance, device-specific credentials used to enable communications amongst different devices and sensors (including the user monitoring gateway) within the user environment. The access data 420 may further include any plain-text information that, if exposed, would not result in exposure of sensitive user information. For example, access data 420 may include contact information of different entities associated with the user (e.g., telephone numbers, e-mail addresses, etc.). Further, the access data 420 may include timestamps or other information denoting when the user has accessed one or more devices and/or sensors within the user environment.

The unregulated data 404 may further include any system configuration information 422 associated with the different devices and sensors (including the user monitoring gateway) implemented in the user environment. For example, the different devices and sensors implemented in the user environment may periodically, or in response to a triggering event, transmit configuration information that provides data corresponding to the software and firmware implemented by these different devices and sensors. This data may be used to determine whether updates are available for these different devices and sensors and that may be installed on these different devices and sensors. Further, if an issue is detected with regard to a particular device or sensor, this particular device or sensor may transmit its system configuration information 422 along with any other data corresponding to the particular issue for diagnostic purposes. The system configuration information 422 may not include any sensitive information associated with the user and the corresponding device or sensor. Thus, such system configuration information 422 may not be subject to any regulations, policies, and/or restrictions.

As opposed to the notifications 416 described above, certain notifications 424 generated by the user monitoring system 106 may be classified as unregulated data 404. For example, notifications that are devoid of any PII, PHI, or other sensitive user information may be classified as unregulated data 404 and disseminated in plain text. As another illustrative example, notifications related to the performance of the devices and sensors within the user environment may be classified as unregulated data 404 if exposure of such performance information would not jeopardize the secure operation of these devices and sensors. In some instances, notifications related to advertisements or marketing of different products and services available to the user may also be classified as unregulated data 404.

Telemetry data 426 associated with the different devices and sensors within the user environment may also be classified as unregulated data 404. This telemetry data 426 may be specific to the operation of the devices and sensors within the user environment and, thus, may be devoid of any sensitive information associated with the user. Telemetry data 426 may include, for example, any firmware or hardware error data corresponding to the user monitoring gateway and/or any of the devices and sensors implemented in the user environment. Further, the telemetry data 426 may include any other performance metrics associated with the operation of the different devices and sensors in the user environment. For instance, the telemetry data 426 may include response times, processor usage, memory usage, storage usage, network-related data (e.g., upload and download speeds, etc.), and the like.

Unregulated data 404 may further include monitoring data 428 corresponding to the different devices and sensors implemented in the user environment. Monitoring data 428 may include, for instance, environment sensor data that may provide further insight into the operation of different devices and sensors in the user environment. Returning to an earlier illustrative example, a device or sensor within the user environment may include an internal thermal sensor that may be used to generate data corresponding to the internal temperature of the device or sensor. As another illustrative example, a device or sensor may include an air quality sensor that may provide data according to certain air quality metrics that may have an impact on users and/or the performance of the device or sensor.

In some instances, the unregulated data 404 may further include external data that may be used to enrich the other data 418-428 maintained by the user monitoring system 106. For example, this external data may include baseline data corresponding to other sample users that may share similar characteristics (e.g., demographics, etc.) to the users associated with the user monitoring gateway. For example, the user monitoring system 106 may obtain, from the gateway health monitoring system, anonymized data corresponding to different users that share similar characteristics to one or more users associated with the user monitoring gateway. This anonymized data may be used to enrich observed data for the detection of possible events occurring within a user environment. The external data may further include data that is specific to the location of the user monitoring gateway and/or of users associated with the user monitoring gateway. For example, the external data may include weather-related data obtained from one or more weather services and corresponding to the location of the user monitoring gateway and/or of users associated with the user monitoring gateway. As another example, the external data may include alerts corresponding to the identified location and that may be informative in identifying possible events occurring within a user environment (e.g., safety notices, recall notices, etc.).

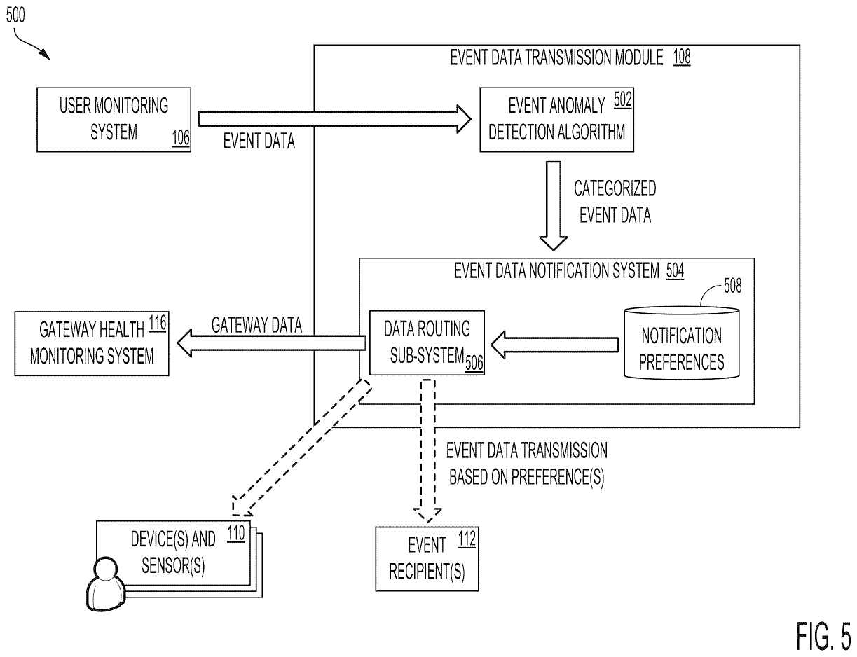

FIG. 5 shows an illustrative example of an environment 500 in which an event data notification system 504 implemented by the user monitoring gateway transmits event data corresponding to a detected event to different recipients based on any applicable preferences in accordance with at least one embodiment. In the environment 500, the event data transmission module 108, through an event anomaly detection algorithm 502, may obtain event data generated by the user monitoring system 106. As noted above, the user monitoring system 106 processes the data segments generated from the ambient data collected from different devices and sensors to generate event data that may be provided to different recipients according to any applicable user preferences and to the classifications of these data segments. The user monitoring system 106 may provide this event data to the event data transmission module 108 to detect any possible user predictive anomalies that may denote one or more issues associated with the user and/or one or more devices and/or sensors within the user environment.

In an embodiment, the event data transmission module 108 implements and dynamically trains an event anomaly detection algorithm 502 to evaluate data corresponding to different events occurring within a user environment to detect any predictive anomalies associated with a user. The event anomaly detection algorithm 502 may be dynamically trained using supervised, unsupervised, or hybrid training techniques. For instance, a dataset of sample event data (e.g., historical data corresponding to previously detected events, hypothetical data corresponding to artificial events, combinations of historical and hypothetical data, etc.), sample user data (e.g., baseline information corresponding to known users, hypothetical baseline information for hypothetical users, combinations of actual and hypothetical baseline information, etc.), and sample predictive anomalies corresponding to the sample event data and sample user data may be analyzed using the event anomaly detection algorithm 502 to identify any correlations between the sample predictive anomalies and any deviations between the sample event data and the sample user data for each data point in the dataset. Based on these correlations, the event anomaly detection algorithm 502 may be dynamically trained to associate different deviations between event data and user data with particular types or categories of predictive anomalies. For instance, based on the type of event data obtained and the deviations between the event data and the user data, the event anomaly detection algorithm 502 may classify the event data according to one or more vectors of similarity between the event data and different types or categories of predictive anomalies.

To implement the event anomaly detection algorithm 502, the event data transmission module 108 may generate an initial iteration of the event anomaly detection algorithm 502 by initializing a set of algorithm coefficients randomly. Using this initial iteration of the event anomaly detection algorithm 502, the event data transmission module 108 may process the dataset of sample event data to generate an output. This output may specify, for each data point corresponding to a particular set of event data, any identified predictive anomalies associated with a sample user and/or with sample sensors and/or devices within a user environment. The event data transmission module 108 may compare the output generated using the initial iteration of the event anomaly detection algorithm 502 to the sample vector values defined in the dataset for each of the data points (e.g., sample ambient data) to identify any inaccuracies or other errors. If the output of the event anomaly detection algorithm 502 does not satisfy one or more criteria, the event data transmission module 108 may iteratively update one or more coefficients of the set of coefficients to generate an updated event anomaly detection algorithm 502. The updated event anomaly detection algorithm 502 may be used to process the aforementioned training dataset, as well as any additional data points or other datasets obtained by the user monitoring gateway to generate a new output for each data point in the training dataset. The event data transmission module 108 may use this updated event anomaly detection algorithm 502 to process the available data points and generate a new output (e.g., new identifications of predictive anomalies based on the sample event data included in the dataset, etc.). The event data transmission module 108 may evaluate this new output to determine whether the output satisfies the one or more criteria. This process of updating the set of coefficients associated with the event anomaly detection algorithm 502 according to the one or more criteria may be performed iteratively until an iteration of the event anomaly detection algorithm 502 is produced that satisfies the one or more criteria for identifying predictive anomalies from obtained event data.

Once the event anomaly detection algorithm 502 has categorized the event data according to the identified predictive anomaly or, if no predictive anomaly was identified, according to the identified event classification, the event anomaly detection algorithm 502 may transmit the categorized event data to an event data notification system 504 for routing the categorized event data to the appropriate entities. The event data notification system 504 may comprise one or more computer systems of the event data transmission module 108 or may be implemented as an application or process executing on a computer system of the event data transmission module 108. In some instances, the event data notification system 504 may be configured with various special-purpose components that can facilitate real-time or near real-time processing of categorized event data as the categorized event data is received to determine how the categorized event data is to be routed to different entities.

As noted above, categorized event data may be transmitted to different entities according to applicable preferences corresponding to the user associated with underlying events. In an embodiment, these preferences are maintained in a notification preferences datastore 508 implemented by the event data notification system 504. The notification preferences datastore 508 may include, for each possible event type or category, a set of notification preferences as defined by the user or proxy for the user (e.g., a caregiver, medical personnel, a family member, etc.) during an onboarding process and/or through interaction with the user health monitoring application or with a web portal implemented by the remote user monitoring system. In some instances, notification preferences may be updated at any time by the user or proxy for the user and subsequently applied to any categorized event data provided by the event anomaly detection algorithm 502. In some instances, the notification preferences may further indicate what actions are to be performed should a particular event not be addressed within a period of time and/or there is an escalation of the particular event (e.g., worsening of a condition, etc.). For instance, the notification preferences may include an indication of different and/or additional entities that may be notified of an event if an initial entity notified regarding an event fails to respond to a notification regarding the event and/or there is an escalation of the event.

The event data notification system 504, as illustrated in FIG. 5, may implement a data routing sub-system 506 that is configured to evaluate categorized event data according to a set of notification preferences associated with the user and from the notification preferences datastore 508 to dynamically determine how to route the categorized event data. Returning to an illustrative example described above, if the categorized event data corresponds to a predictive anomaly that requires immediate medical attention (e.g., sudden changes to a user's blood pressure and/or pulse, detection of user losing consciousness, sudden slurring of speech, etc.), the data routing sub-system 506 may evaluate the user preferences associated with the user from the notification preferences datastore 508 to determine that the event data is to be transmitted to medical personnel that may be able to address the possible medical emergency. As another illustrative example, if the categorized event data corresponds to a predictive anomaly associated with the user's eating habits (e.g., the user is exhibiting a loss of appetite, the user is experiencing stomach discomfort when eating, the user is regurgitating any ingested food, etc.), the data routing sub-system 506 may evaluate the user preferences associated with the user from the notification preferences datastore 508 to determine that, for this particular type of predictive anomaly, the event data is to be transmitted to one or more event recipients 112 associated with the user. These one or more event recipients 112 may use this data to further evaluate the user to determine the cause of the predictive anomaly.

In some instances, if the categorized event data corresponds to a predictive anomaly or other type of event that may be addressed through one or more devices and/or sensors 110 implemented in the user environment, the data routing sub-system 506 may dynamically generate one or more executable instructions or commands that may be transmitted to these devices and/or sensors 110 to address the event. Returning to an earlier illustrative example, if categorized event data corresponds to a predictive anomaly associated with a user's blood glucose levels, but the predictive anomaly does not rise to the level of requiring immediate medical attention, the data routing sub-system 506 may transmit one or more executable instructions or commands to the user's blood glucose monitor to obtain additional blood glucose readings over a period of time. These additional blood glucose readings may be used to determine whether there is a possible issue with the user or with the blood glucose monitor itself. As another illustrative example, if categorized event data corresponds to a predictive anomaly associated with a user's body temperature and the data routing sub-system 506 determines that the air conditioning system within the user environment is set to a high temperature, the data routing sub-system 506 may automatically transmit executable instructions or other commands to the air conditioning system to lower the temperature within the user environment. Thus, the data routing sub-system 506 may automatically communicate with the different devices and/or sensors 110 within the user environment to try and address any predictive anomalies that do not require immediate intervention. For instance, the data routing sub-system 506 may transmit executable instructions to the different devices and/or sensors 110 that may be executed by these devices and/or sensors 110 to try and address these predictive anomalies. The data routing sub-system 506 may monitor execution of these executable instructions to determine whether these executable instructions are being executed successfully by the devices and/or sensors 110. If the data routing sub-system 506 detects that these executable instructions are not being executed successfully (e.g., a device or sensor returns an error message, a device or sensor fails to communicate a response or other indication of execution of the executable instructions, etc.), the data routing sub-system 506 may transmit a notification to the event anomaly detection algorithm 502 indicating a possible issue with the device or sensor. This may result in an escalation of the predictive anomaly to one or more other event recipients 112 according to any applicable notification preferences.

In some instances, the categorized event data may include gateway-specific data corresponding to the user monitoring gateway itself. This gateway-specific data may include telemetry data associated with the user monitoring gateway, performance metrics corresponding to the performance of different components of the user monitoring gateway, networking data corresponding to any communications channels associated with the user monitoring gateway, and the like. If the categorized event data includes gateway-specific data, the data routing sub-system 506 may automatically transmit this gateway-specific data to the gateway health monitoring system 116. As noted above, the gateway health monitoring system 116 may be implemented by a remote user monitoring service, which may provide user monitoring gateways to different users to monitor the health of these users and to perform the various functionalities described herein. The remote gateway health monitoring system 116 may continuously, in real-time or near real-time, evaluate received device data associated with the user monitoring gateway to determine whether there are any issues impacting the performance of the user monitoring gateway. Based on any identified errors, the gateway health monitoring system 116 may transmit the device data to one or more entities that may be able to address the identified errors associated with the user monitoring gateway.

In an embodiment, the event data transmission module 108 dynamically updates the event anomaly detection algorithm 502 according to any feedback obtained with regard to the identification of predictive anomalies and the categorization of event data from the user monitoring system 106. For example, if the event anomaly detection algorithm 502 fails to detect a particular predictive anomaly associated with the user, the event data transmission module 108 may update the dataset used to train the event anomaly detection algorithm 502 implemented by the event data transmission module 108 to add a data point that indicates, for the particular event data from which the predictive anomaly was missed, the predictive anomaly that should have been detected. The updated training dataset may be used to evaluate the performance of the event anomaly detection algorithm 502 and, accordingly, generate a new iteration of the event anomaly detection algorithm 502 that may be evaluated to determine whether this new iteration more accurately detects predictive anomalies from provided event data. This iterative process may continue until an iteration of the event anomaly detection algorithm 502 is generated that satisfies one or more criteria. Thus, as event data is obtained, predictive anomalies are identified, and the event data is categorized according to different classifications in real-time or near real-time, the event anomaly detection algorithm 502 is continuously updated to better identify any predictive anomalies that may necessitate action from one or more entities.

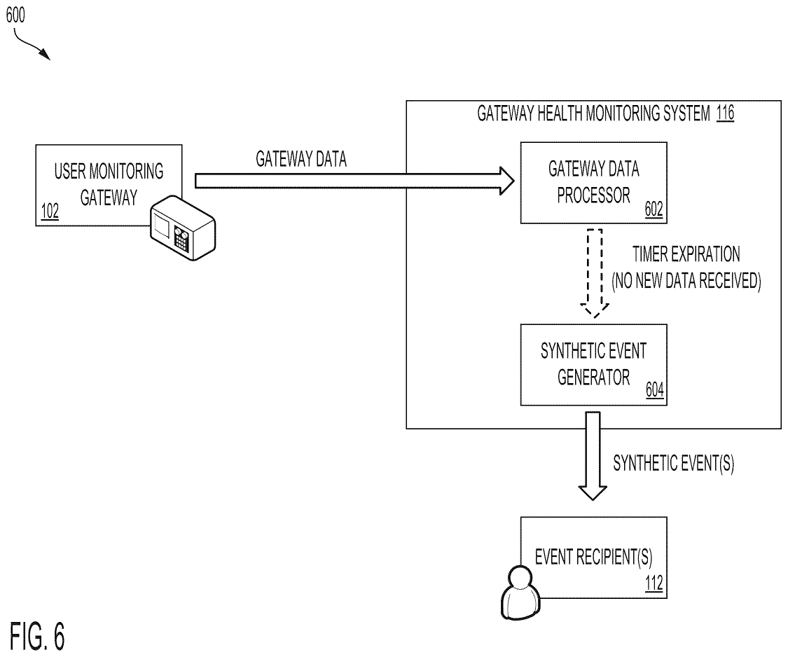

FIG. 6 shows an illustrative example of an environment 600 in which a gateway health monitoring system 116 processes gateway data from a user monitoring gateway 102 to monitor the health of the user monitoring gateway 102 in accordance with at least one embodiment. In the environment 600, the gateway health monitoring system 116, through a gateway data processor 602, may continuously receive gateway data from a user monitoring gateway 102 implemented in a user environment. As noted above, the gateway health monitoring system 116 may be implemented by a remote user monitoring service, which may provide user monitoring gateways to different users to monitor the health of these users and to perform the various functionalities described herein. In an embodiment, the gateway health monitoring system 116, through the gateway data processor 602, may continuously, in real-time or near real-time, evaluate received gateway data associated with the user monitoring gateway 102 to determine whether there are any issues impacting the performance of the user monitoring gateway 102. The gateway data associated with the user monitoring gateway 102, for instance, may indicate any errors encountered by the user monitoring gateway 102 during operation (e.g., any software or hardware failure codes or indicators, communication errors associated with the different devices and sensors, battery capacity issues, firmware and/or software update or execution failures, detection of user tampering of the user monitoring gateway 102, etc.). Based on these identified errors, the gateway health monitoring system 116 may transmit the device data to notification recipients 606 that may be able to address the identified errors associated with the user monitoring gateway 102 (e.g., technicians associated with the user monitoring service, the user, a caregiver associated with the user, etc.).

In an embodiment, and as illustrated in FIG. 6, the gateway data processor 602 further monitors the user monitoring gateway 102 to automatically detect if the user monitoring gateway 102 is no longer transmitting gateway health data. For instance, the gateway data processor 602 may initiate a timer corresponding to the amount of time since the gateway health monitoring system 116 has received gateway health data from the user monitoring gateway 102. If the gateway health monitoring system 116 receives new gateway health data from the user monitoring gateway 102, the gateway data processor 602 may automatically reset the timer. However, if the gateway health monitoring system 116 does not receive any gateway health data from the user monitoring gateway 102, the gateway data processor 602 may continue to automatically increment the timer to denote the amount of the time since gateway health data was received from the user monitoring gateway 102.

The timer implemented by the gateway data processor 602 may be subject to a pre-defined or maximum amount of time that may elapse before the timer is deemed to be expired. This maximum amount of time may correspond to a threshold amount of time that may elapse since new gateway data was received from the user monitoring gateway 102. In an embodiment, if the gateway data processor 602 detects that the timer associated with the user monitoring gateway 102 has expired, the gateway data processor 602 transmits an indication to a synthetic event generator 604 implemented by the gateway health monitoring system 116 that no gateway data has been received from the user monitoring gateway 102 over a threshold period of time. If the synthetic event generator 604 receives this indication from the gateway data processor 602, the synthetic event generator 604 may automatically generate one or more synthetic events that may denote possible issues with the user monitoring gateway 102, as the lack of gateway data from the user monitoring gateway 102 may represent one or more possible issues related to the performance of the user monitoring gateway 102. Returning to an earlier illustrative example, the lack of gateway data may represent a failure of the hardware and/or software of the user monitoring gateway 102. As another illustrative example, the lack of gateway data may represent power-related issues, such a power outage within the user environment, a battery or other power supply failure, and the like.

The synthetic events generated by the synthetic event generator 604 may include an indication of the last time that gateway data was received by the gateway health monitoring system 116 from the user monitoring gateway 102 (e.g., a timestamp corresponding to the most recently received gateway data, etc.). Additionally, or alternatively, the synthetic events may include one or more portions of the previously obtained gateway data up to the most recently received gateway data. This may help a recipient of the synthetic events to review these portions of the previously obtained gateway data for diagnostic and/or troubleshooting purposes (e.g., identifying the root cause of the lack of new gateway data, etc.). The synthetic event generator 604, in some instances, may transmit the synthetic events associated with a lack of gateway data to one or more notification recipients 606 to address any possible issues associated with the user monitoring gateway 102. For instance, the synthetic event generator 604 may transmit a synthetic event to one or more technicians trained to service user monitoring gateways and to address any issues that may impact performance of these user monitoring gateways. As another illustrative example, the synthetic event generator 604 may transmit the synthetic events to the user or other entity associated with the user (e.g., medical personnel, a caregiver, etc.) to troubleshoot any issues associated with the user monitoring gateway and provide any additional information to the gateway health monitoring system 116 in the event that these issues cannot be resolved by the user or other entity.

The synthetic event generator 604, in an embodiment, can escalate different synthetic events corresponding to the user monitoring gateway 102 as the period of time since the corresponding timer has expired continues to elapse. For example, when the aforementioned timer first expires, the synthetic event generator 604 may initially transmit the synthetic events associated with the user monitoring gateway 102 to the user or to another entity associated with the user that has access to the user monitoring gateway 102 to allow the user or other entity to troubleshoot any possible issues with the user monitoring gateway 102. If the gateway health monitoring system 116 continues to receive no new gateway data from the user monitoring gateway 102, the synthetic event generator 604 may transmit the synthetic events and/or new synthetic events corresponding to the continued lack of gateway data to one or more technicians that may be dispatched to the user environment to inspect the user monitoring gateway 102 and address any identified issues associated with the user monitoring gateway 102.

As noted above, in some instances, the gateway data from the user monitoring gateway 102 may include data corresponding to communications between the user monitoring gateway 102 and the different devices and sensors within the user environment. For example, the gateway data may include timestamps corresponding to communications exchanged between the different devices and sensors within the user environment and the user monitoring gateway 102. In an embodiment, the gateway data processor 602 can evaluate the gateway data from the user monitoring gateway 102 using the aforementioned timer to dynamically detect any lack of communications between the user monitoring gateway 102 and one or more devices and/or sensors within the user environment. If a timer corresponding to gateway data associated with communications between the user monitoring gateway 102 and a particular device or sensor expires, it may denote an issue with the user monitoring gateway 102 and/or the particular device or sensor. Further, based on which devices and/or sensors are impacted, the synthetic event generator 604 may automatically generate device/sensor-specific synthetic events that may be transmitted to one or more notification recipients 606 that may be able to address any issues associated with the connections or other communications channels between the user monitoring gateway 102 and the one or more devices and/or sensors.

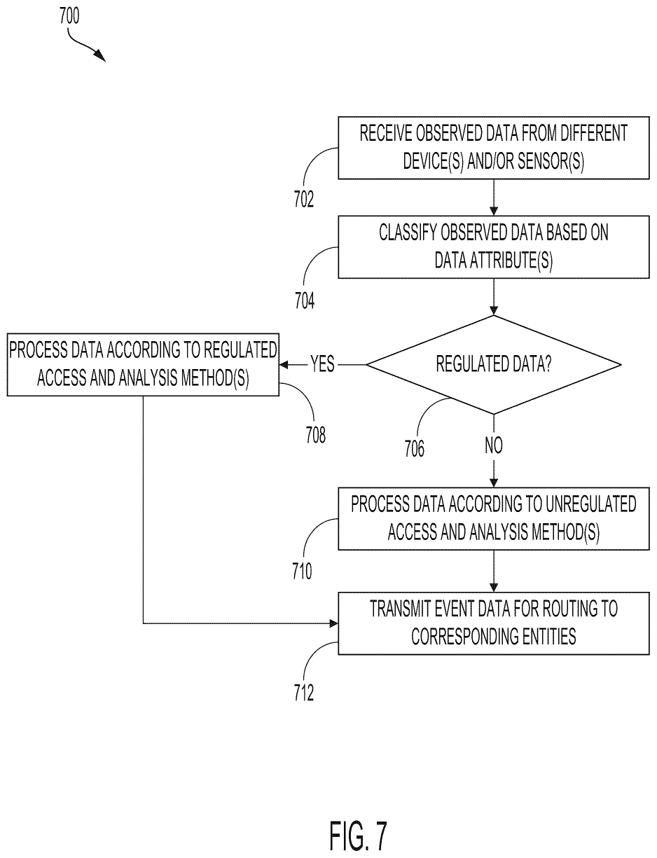

FIG. 7 shows an illustrative example of a process 700 for classifying and processing observed data from different devices and sensors in a user environment in accordance with at least one or more embodiments. The process 700 may be performed by the aforementioned user monitoring system, which may dynamically process ambient data from different devices and sensors to segment the ambient data according to different data classifications and detect any events associated with these classified data segments. In some instances, certain operations of the process 700 may be performed by one or more trained machine learning algorithms or artificial intelligence systems, such as the data segment analysis algorithms 212-216 described above in connection with FIG. 2.

At step 702, the user monitoring system may receive observed ambient data from one or more devices and/or sensors implemented in the user environment. As noted above, the user monitoring system may implement a data segmentation module that is configured to obtain real-time ambient data from a data cache maintained by a data collection module of the user monitoring gateway. This data collection module may automatically obtain ambient data from the myriad devices and sensors implemented in the user environment and store this ambient data in the data cache. In some instances, the data collection module may implement a timer that may be used to define the amount of time ambient data may be stored in the data cache before the ambient data is automatically transmitted to the user monitoring system for classification, segmentation, and dissemination to different recipients. The data collection module, in some instances, may automatically transmit the ambient data to the user monitoring system in response to a triggering event, such as any events requiring immediate attention.

At step 704, the user monitoring system may classify the received ambient data based on different data attributes. For instance, through the data segmentation module, the user monitoring system may process the ambient data to generate different data segments according to different data classifications or categories. These different data classifications or categories may be defined according to the different regulations, policies, or other restrictions that are applicable to different types of data generated by the different devices and sensors within the user environment. Returning to an earlier illustrative example, any data including PII or PHI of a user may be subject to HIPAA or other privacy-related regulations whereby additional safeguards may be required to prevent unauthorized dissemination of such data to unauthorized entities. Alternatively, data related to the performance of these devices and sensors, as well as of the user monitoring gateway itself, may not be subject to such regulations and thus may be evaluated without any additional safeguards.

If the user monitoring system implements a machine learning algorithm or artificial intelligence to generate the different data segments according to different data classifications or categories, the machine learning algorithm or artificial intelligence may be dynamically trained using a dataset that includes data classifications that may serve as indications as to whether data is regulated (i.e., subject to one or more regulations, policies, or other restrictions) or unregulated. For example, data that is classified as being user health data may also be classified as being regulated and, thus, requiring separate processing and handling by the user monitoring gateway. As another illustrative example, data that is classified as being device data may also be classified as being unregulated data such that this data can be processed through any available methods implemented by the user monitoring gateway. Thus, the machine learning algorithm or artificial intelligence implemented by the data segmentation module may be dynamically trained to perform an initial classification of the ambient data according to the data attributes of the ambient data for segmentation and, subsequently, perform a second classification of the individual data segments according to the types of initial classifications assigned to the individual data segments.

At step 706, the user monitoring system may determine whether any of the data segments generated by the data segmentation module include regulated data requiring separate processing. If any of the data segments have been classified as including regulated data requiring separate processing, the user monitoring system, at step 708, may process these data segments according to regulated access and analysis methods. As noted above, the user monitoring system may implement distinct processing modules according to the different classifications or categories that may be assigned to different data segments. These distinct processing modules may be maintained in isolation from one another (such as through the implementation of software containers for each processing module) to prevent intermingling of different types of data segments and to allow for processing of these different types of data segments in compliance of any applicable regulations, policies, or other restrictions. Data segments that are classified as including regulated data may be dynamically routed to a processing module that is implemented to process such data segments in compliance with the regulations, policies, or other restrictions that may be applicable to the regulated data included therein. Data segments that do not include regulated data may be processed according to unregulated access and analysis methods at step 710. For instance, such data segments may be processed through the processing modules corresponding to the type of data included within the data segments (e.g., device data, user interaction data, etc.). These particular processing modules may be implemented without need for special controls for compliance with any regulations, policies, or other restrictions.

At step 712, the user monitoring system may transmit event data corresponding to different events detected with the user environment for routing to one or more corresponding entities, such as medical personnel, caregivers, multiple family members, and the like. Event data generated by a particular data processing module implemented by the user monitoring system may include metadata denoting the classification or category of the ambient data that was processed to generate the event data. Additionally, the metadata may denote an identifier or other indicator of the type of event detected and associated with the event data. This may allow for collection of event data corresponding to a particular type of event without exposing or intermingling of any of the underlying data. For instance, encrypted health data corresponding to a particular event may be collected with unencrypted user interaction data corresponding to the particular event without need to decrypt the encrypted health data. As the user monitoring system, through the data processing modules, generates event data corresponding to different user and/or user monitoring gateway events, the user monitoring system may provide this event and/or user monitoring gateway data to an event data transmission module for dissemination to different entities according to any applicable user preferences and/or user monitoring gateway settings.

It should be noted that the process 700 may be performed continuously and simultaneously for different ambient data as the ambient data is received. For instance, the user monitoring system may continuously and simultaneously process different ambient data from the different devices and/or sensors in the user environment in real-time or near real-time as the different data is received to generate and classify different data segments. Further, as these data segments are generated, the user monitoring system may continuously and simultaneously process these different data segments according to whether these data segments include or do not include regulated data. Thus, the user monitoring system may continuously and simultaneously process any amount of ambient data from different sensors and/or devices within the user environment in real-time or near real-time as the ambient data is received to dynamically segment and classify the ambient data according to any applicable regulations, policies, or other restrictions. Further, the user monitoring system may process these data segments through different processing modules configured according to these regulations, policies, or other restrictions to generate event data that may be transmitted for routing to corresponding entities.

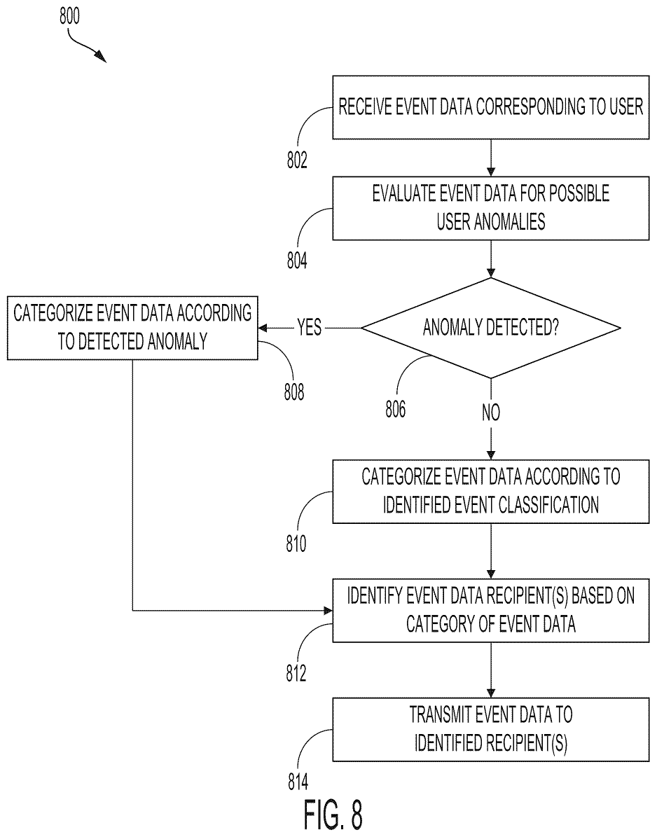

FIG. 8 shows an illustrative example of a process 800 for categorizing event data corresponding to different events detected within a user environment and transmitting the event data to different recipients according to the categorization in accordance with at least one embodiment. The process 800 may be performed by the aforementioned event data transmission module, which may dynamically process event data from the user monitoring system of the user monitoring gateway to identify any predictive anomalies corresponding to a user associated with the underlying events, categorize the event data according to any identified predictive anomalies, and disseminate the categorized event data to corresponding recipients. In some instances, certain operations of the process 800 may be performed by one or more trained machine learning algorithms or artificial intelligence systems.

At step 802, the event data transmission module receives event data corresponding to a particular user in the user environment. This event data may be obtained from the user monitoring system implemented by the user monitoring gateway. As noted above, the user monitoring system processes the data segments generated from the ambient data collected from different devices and sensors to generate event data that may be provided to different recipients according to any applicable user preferences and to the classifications of these data segments. The user monitoring system may provide this event data to the event data transmission module to detect any possible user predictive anomalies that may denote one or more issues associated with the user and/or one or more devices and/or sensors within the user environment.

At step 804, the event data transmission module may evaluate the received event data to identify any predictive anomalies associated with the user. As noted above in connection with FIG. 5, the event data transmission module may implement and train an event anomaly detection algorithm to evaluate the received event data to detect any predictive anomalies associated with a user. A user predictive anomaly is an event that represents a deviation from a user's baseline or routine activities, behaviors, physiological state, or other attribute. Further, user predictive anomalies may represent motor control issues, cognitive issues, physical degradation, or other user physiological issues that may require additional attention. User predictive anomalies may be evaluated in the context of different physiological systems to which the event data may be related. For example, if the event data corresponds to a user's blood pressure, heart rate, and cardiac rhythm, this event data may be evaluated according to the user's cardiovascular system as this data may be indicative of a possible cardiac or other circulatory system issue. To detect any predictive anomalies represented in event data, the event data transmission module, through the event anomaly detection algorithm, may dynamically process the received event data and baseline data associated with the user (e.g., data corresponding to user baseline or routine activities, behaviors, physiological state, or other attributes, etc.). As the event anomaly detection algorithm is dynamically trained to identify correlations between predictive anomalies and any deviations between the event data and user baseline data, the event anomaly detection algorithm may dynamically evaluate any detected deviations between event data and user baseline data and determine whether these detected deviations correspond to particular types or categories of predictive anomalies. Thus, through this evaluation, the event data transmission module may determine, at step 806, whether any predictive anomalies have been detected.

If the event data transmission module detects one or more predictive anomalies, the event data transmission module, at step 808, may categorize the corresponding event data according to the detected one or more predictive anomalies. Alternatively, if event data associated with a user does not represent a predictive anomaly, the event data transmission module, at step 810, may instead categorize the event data according to the identified event classification (e.g., type of event detected, etc.). Once the event anomaly detection algorithm has categorized the event data according to the identified predictive anomaly or, if no predictive anomaly was identified, according to the identified event classification, the event data transmission module, at step 812, may identify the intended recipients for the categorized event data. As noted above, categorized event data may be transmitted to different entities according to applicable user preferences associated with the underlying events. For each possible event type or category, the event data transmission module may maintain a set of notification preferences as defined by the user or proxy for the user (e.g., a caregiver, medical personnel, a family member, etc.) during an onboarding process and/or through interaction with the user health monitoring application or with a web portal implemented by the remote user monitoring system. In some instances, notification preferences may be updated at any time by the user or proxy for the user and subsequently applied to any categorized event data.

At step 814, the event data transmission module may transmit the categorized event data to corresponding recipients according to the identified notification preferences. Returning to an illustrative example described above, if the categorized event data corresponds to a predictive anomaly that requires immediate medical attention, the event data transmission module may evaluate the user preferences associated with the user to determine that the event data is to be transmitted to medical personnel that may be able to address the possible medical emergency. As another illustrative example, if the categorized event data corresponds to a predictive anomaly associated with the user's eating habits, the event data transmission module may evaluate the user preferences associated with the user to determine that, for this type of predictive anomaly, the event data is to be transmitted to a caregiver associated with the user. The caregiver may use this data to further evaluate the user to determine the cause of the predictive anomaly. As yet another illustrative example, if the categorized event data corresponds to a predictive anomaly or other type of event that may be addressed through one or more devices and/or sensors implemented in the user environment, the event data transmission module may dynamically generate one or more executable instructions or commands that may be transmitted to these devices and/or sensors to address the event.

Similar to the process 700 described above, the process 800 may be performed continuously and simultaneously for different event data as the event data is received. For instance, the event data transmission module may continuously and simultaneously process different event data corresponding to different events occurring in the user environment in real-time or near real-time as the different event data is received from the user monitoring system to detect any predictive anomalies associated with a user within the user environment. Further, as the different event data is categorized according to the type of event and to the presence or absence of predictive anomalies, the event data transmission module may continuously and simultaneously process the different categorized event data according to any applicable user preferences to dynamically identify the intended recipients for the different categorized event data. Thus, the event data transmission module may continuously and simultaneously process any event data in real-time or near real-time as the event data is received to dynamically detect any predictive anomalies and ensure that the event data is provided to intended recipients that may be able to address the predictive anomalies or other events occurring in the user environment.

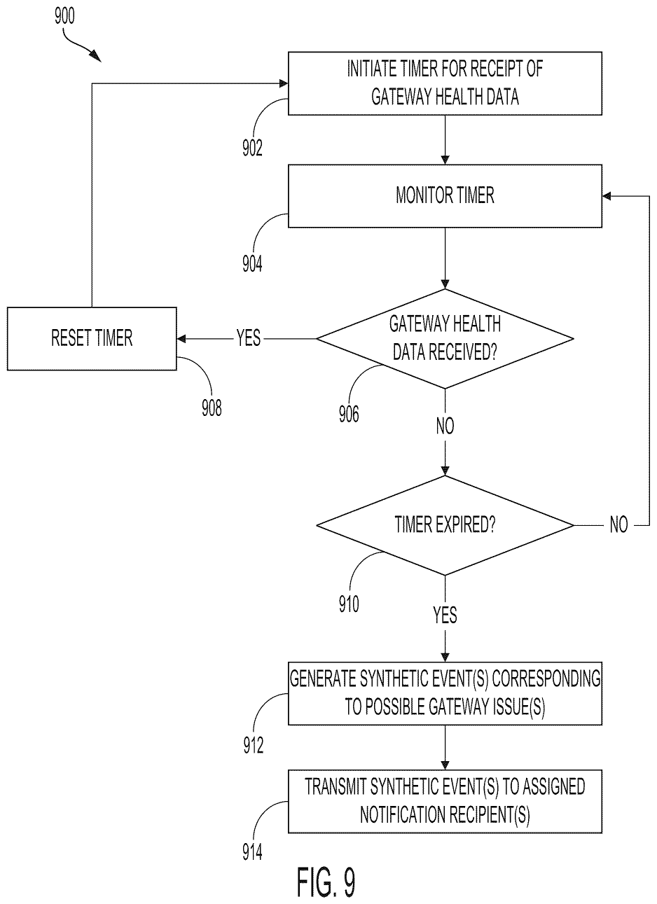

FIG. 9 shows an illustrative example of a process 900 for monitoring data associated with a user monitoring gateway to dynamically detect any possible issues with the user monitoring gateway in accordance with at least one embodiment. The process 900 may be performed by the aforementioned gateway health monitoring system. It should be noted that while the present process 900 is described for a single user monitoring gateway, the gateway health monitoring system may continuously and simultaneously execute the process 900 for any number of user monitoring gateways implemented in different user environments.

At step 902, the gateway health monitoring system may initiate a timer corresponding to the receipt of gateway health data from a user monitoring gateway. The timer implemented by the gateway health monitoring system may denote an amount of time since the gateway health monitoring system has received gateway health data from the user monitoring gateway. Thus, once the gateway health monitoring system receives new gateway health data from a user monitoring gateway, the gateway health monitoring system may automatically initiate a timer associated with this user monitoring gateway.

At step 904, the gateway health monitoring system may monitor the timer. For instance, i the gateway health monitoring system does not receive any gateway health data from the user monitoring gateway, the gateway health monitoring system may continue to automatically increment the timer to denote the amount of the time since gateway health data was received from the user monitoring gateway. As the gateway health monitoring system monitors the timer, the gateway health monitoring system, at step 906, may determine whether new gateway health data has been received from the user monitoring gateway. If the gateway health monitoring system has received new gateway health data from the user monitoring gateway, the gateway health monitoring system, at step 908, may reset the timer and re-initiate the timer, thereby restarting the process 900.

If the gateway health monitoring system has not received new gateway health data from the user monitoring gateway, the gateway health monitoring system may determine, at step 910, whether the timer has expired. As noted above, the timer implemented by the gateway health monitoring system may be subject to a pre-defined or maximum amount of time that may elapse before the timer is deemed to be expired. This maximum amount of time may correspond to a threshold amount of time that may elapse since new gateway health data was received from the user monitoring gateway. If the timer has not expired (e.g., the maximum or threshold amount of time has not elapsed), the gateway health monitoring system may continue to monitor the timer at step 904.

If the gateway health monitoring system detects that the timer associated with the user monitoring gateway has expired, the gateway health monitoring system, at step 912, may generate one or more synthetic events corresponding to possible issues associated with the user monitoring gateway. Returning to an earlier illustrative example, the lack of gateway health data may represent a failure of the hardware and/or software of the user monitoring gateway. As another illustrative example, the lack of gateway data may represent power-related issues, such a power outage within the user environment, a battery or other power supply failure, and the like. The synthetic events generated by the gateway health monitoring system may include an indication of the last time that gateway health data was received by the gateway health monitoring system from the user monitoring gateway (e.g., a timestamp corresponding to the most recently received gateway data, etc.). Additionally, or alternatively, the synthetic events may include one or more portions of the previously obtained gateway health data up to the most recently received gateway data. This may help a recipient of the synthetic events to review these portions of the previously obtained gateway data for diagnostic and/or troubleshooting purposes (e.g., identifying the root cause of the lack of new gateway data, etc.).

At step 914, the gateway health monitoring system may transmit the one or more synthetic events to assigned notification recipients to address any possible issues associated with the user monitoring gateway. For instance, the gateway health monitoring system may transmit a synthetic event to one or more technicians trained to service user monitoring gateways and to address any issues that may impact performance of these user monitoring gateways. As another illustrative example, the gateway health monitoring system may transmit the synthetic events to the user or other entity associated with the user (e.g., medical personnel, a caregiver, etc.) to troubleshoot any issues associated with the user monitoring gateway and provide any additional information to the gateway health monitoring system in the event that these issues cannot be resolved by the user or other entity.

In some instances, the process 900 may include additional and/or alternative operations. For instance, the gateway health monitoring system, in an embodiment, can escalate different synthetic events corresponding to the user monitoring gateway as the period of time since the corresponding timer has expired continues to elapse. For example, when the aforementioned timer first expires, the gateway health monitoring system may initially transmit the synthetic events associated with the user monitoring gateway to the user or to another entity associated with the user that has access to the user monitoring gateway to allow the user or other entity to troubleshoot any possible issues with the user monitoring gateway. If the gateway health monitoring system continues to receive no new gateway data from the user monitoring gateway, the gateway health monitoring system may transmit the synthetic events and/or new synthetic events corresponding to the continued lack of gateway data to one or more technicians that may be dispatched to the user environment to inspect the user monitoring gateway and address any identified issues associated with the user monitoring gateway.

The process 900 may further include detection of issues related to communications channels between the user monitoring gateway and the different devices and sensors implemented in the user environment. As noted above, in some instances, the gateway health data from the user monitoring gateway may include data corresponding to communications between the user monitoring gateway and the different devices and sensors within the user environment. For example, the gateway health data may include timestamps corresponding to communications exchanged between the different devices and sensors within the user environment and the user monitoring gateway. In an embodiment, the gateway health monitoring system can evaluate the gateway health data from the user monitoring gateway using the aforementioned timer to dynamically detect any lack of communications between the user monitoring gateway and one or more devices and/or sensors within the user environment. If a timer corresponding to gateway data associated with communications between the user monitoring gateway and a particular device or sensor expires, it may denote an issue with the user monitoring gateway and/or the particular device or sensor. Further, based on which devices and/or sensors are impacted, the gateway health monitoring system may automatically generate device/sensor-specific synthetic events that may be transmitted to one or more notification recipients that may be able to address any issues associated with the connections or other communications channels between the user monitoring gateway and the one or more devices and/or sensors.

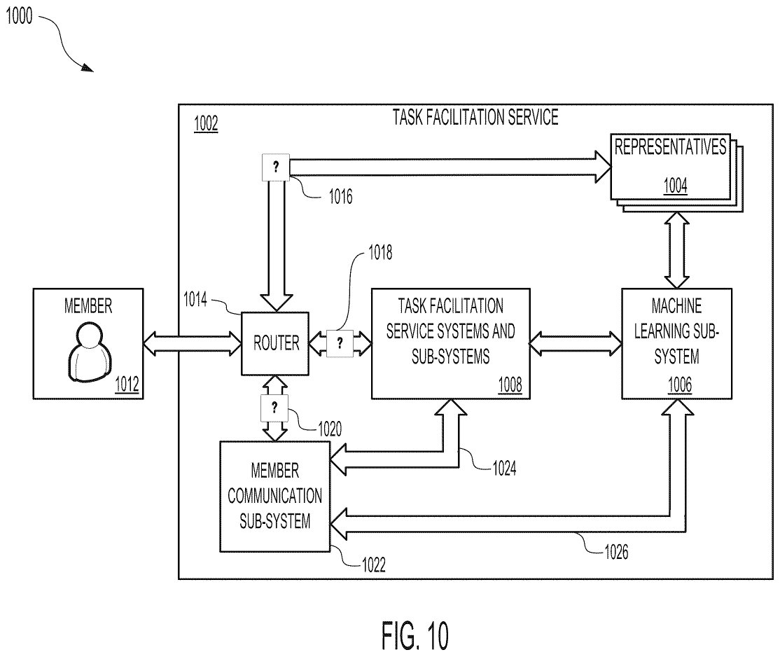

FIG. 10 shows an illustrative example of an environment 1000 in which communications with members are processed in accordance with at least one embodiment. In an embodiment, operations performed by representatives 1004 are partially and/or fully performed using one or more machine learning algorithms, artificial intelligence systems and/or computational models. For example, as the representatives 1004 perform or otherwise coordinate performance of tasks on behalf of a member 1012, the task facilitation service 1002 may update a profile of the member 1012 and/or a computational model of the profile of the member 1012.

In an embodiment, as the representatives 1004 perform or otherwise coordinate performance of tasks on behalf of a member 1012, the task facilitation service 1002 updates a profile of the member 1012 and/or a computational model of the profile of the member 1012 continuously. For example, as a member 1012 communicates with a system of the task facilitation service 1002, the task facilitation service 1002 may update the profile of the member 1012 and/or a computational model of the profile of the member 1012 continuously during the course of the interaction.

In an embodiment, as the representatives 1004 perform or otherwise coordinate performance of tasks on behalf of a member 1012, the task facilitation service 1002 updates a profile of the member 1012 and/or a computational model of the profile of the member 1012 dynamically. For example, as a task is performed on behalf of a member 1012, a vendor performing the task may provide regular updates to the task facilitation service 1002 and the task facilitation service 1002 may update the profile of the member 1012 and/or a computational model of the profile of the member 1012 dynamically at each update from the vendor.

In an embodiment, as the representatives 1004 perform or otherwise coordinate performance of tasks on behalf of a member 1012, the task facilitation service 1002 updates a profile of the member 1012 and/or a computational model of the profile of the member 1012 automatically. For example, when a proposal is generated for the member, the task facilitation service 1002 may update the profile of the member 1012 and/or a computational model of the profile of the member 1012 automatically as part of the proposal generation process.

In an embodiment, as the representatives 1004 perform or otherwise coordinate performance of tasks on behalf of a member 1012, the task facilitation service 1002 updates a profile of the member 1012 and/or a computational model of the profile of the member 1012 in real-time. For example, when a member 1012 accepts a proposal, the task facilitation service 1002 may update the profile of the member 1012 and/or a computational model of the profile of the member 1012 at the time that the proposal acceptance is provided, rather than delaying the update.

In an embodiment, the task facilitation service 1002 updates a profile of the member 1012 and/or a computational model of the profile of the member 1012 using a machine learning sub-system 1006 of the task facilitation service 1002. In an embodiment, a machine learning sub-system 1006 is a component of the task facilitation service 1002 that is configured to implement machine learning algorithms, artificial intelligence systems, and/or computation models. In an example, a machine learning sub-system 1006 may use various algorithms to train a machine learning model using sample and/or live data. Additionally, a machine learning sub-system 1006 may update the machine learning model as new data is received. In another example, the machine learning sub-system 1006 may train and/or update various artificial intelligence systems or generate, train and/or update various computational models. For example, a computational model of the profile of the member 1012 may be generated, trained and/or updated by the machine learning sub-system 1006 as new information is received about the member 1012.

In an embodiment, after the profile of the member 1012 and/or a computational model of the profile of the member 1012 has been updated over a period of time (e.g., six months, a year, etc.) and/or over a set of tasks (e.g., twenty tasks, thirty tasks, etc.), systems of the task facilitation service 1002 (e.g., a task recommendation system) utilize one or more machine learning algorithms, artificial intelligence systems and/or computational models to generate new tasks continuously, automatically, dynamically, and in real-time. For example, the task recommendation system may generate new tasks based on the various attributes of the member's profile (e.g., historical data corresponding to member-representative communications, member feedback corresponding to representative performance and presented tasks/proposals, etc.) with or without representative interaction. In an embodiment, systems of task facilitation service 1002 (e.g., a task recommendation system) can automatically communicate with the member 1012 to obtain any additional information needed and can also generate proposals that may be presented to the member 1012 for performance of these tasks.

In the example illustrated in FIG. 10, communications between the member 1012 and the task facilitation service 1002 may be routed to one or more entities within the task facilitation service 1002. The example illustrated in FIG. 10 shows a communication router 1014 (referred to in the illustration as a “router”) however, as may be contemplated and as illustrated in FIG. 10, the router 1014 is an abstract representation of one or more techniques for routing communications between entities. Accordingly, communications from the member 1012 to the task facilitation service 1002 may be routed to one or more entities of the task facilitation service and communications from the one or more entities of the task facilitation service 1002 may be routed back to the member 1012.

In the example illustrated in FIG. 10, the representatives 1004 can monitor communications between task facilitation service systems and/or sub-systems 1008 and the member 1012 to ensure that the interaction maintains a positive polarity as described herein because the communications can be routed 1016 to the representatives 1004 and also routed 1018 to task facilitation service systems and/or sub-systems 1008. For example, if a member 1012 is interacting with the task recommendation system, the representatives 1004 can determine whether the member 1012 is satisfied with the interaction. If the representatives 1004 determine that the conversation has a negative polarity (e.g., that the member 1012 is not satisfied with the interaction), the representatives 1004 may intervene to improve the interaction.

Similarly, other interactions between task facilitation service systems and/or sub-systems 1008 and the member 1012 may be routed 1020 to a member communication sub-system 1022 which may be configured to monitor the interactions between task facilitation service systems and/or sub-systems 1008 and the member 1012. In an embodiment, the member communication sub-system 1022 can be configured to intercept the interactions between task facilitation service systems and/or sub-systems 1008 and the member 1012 (using, for example, the router 1014). In such an embodiment, all such interactions can be routed 1020 between the member 1012 and the member communication sub-system 1022 and can be routed 1024 between the member communication sub-system 1022 and the task facilitation service systems and/or sub-systems 1008. In such an embodiment, interactions between the task facilitation service systems and/or sub-systems 1008 and the member 1012 may not be routed 1018 directly. In such an embodiment, the representatives 1004 may still monitor interactions between task facilitation service systems and/or sub-systems 1008 and the member 1012 to ensure that the interaction maintains a positive polarity as described above (e.g., by routing 1016 the interactions to the representatives 1004).

In an embodiment, the representatives 1004 can interact with the machine learning sub-system 1006 to update the profile of the member indicating changing member preferences based on an interaction between the representatives 1004 the member 1012. In an embodiment, the task facilitation service systems and/or sub-systems 1008 can interact with the machine learning sub-system 1006 to update the profile of the member when, for example, a proposal is accepted or rejected. Additionally, as illustrated in FIG. 10, the interactions between the task facilitation service 1002 and the member 1012 can be additionally routed 1026 between the member communication sub-system 1022 and the machine learning sub-system 1006. Accordingly, interactions between the member 1012 and, for example, a proposal creation sub-system may be used to update the profile of the member as a proposal is created.

Thus, unlike automated customer service systems and environments, wherein the systems and environment may have little or no knowledge of users interacting with agents and/or other automated systems, task facilitation service systems and/or sub-systems 1008 can update the profile of the member 1012 and/or a computational model of the profile of the member 1012 continuously, dynamically, automatically, and/or in real-time. For example, task facilitation service systems and/or sub-systems 1008 can update the profile of the member 1012 and/or a computational model of the profile of the member 1012 using the machine learning sub-system 1006 as described herein. Accordingly, task facilitation service systems and/or sub-systems 1008 can update the profile of the member 1012 and/or a computational model of the profile of the member 1012 to provide up-to-date information about the member based on the member's automatic interaction with the task facilitation service 1002, based on the member's interaction with the representative 1004, and/or based on tasks performed on behalf of the member 1012 over time. This information may also be updated continuously, automatically, dynamically, and/or in real-time as tasks and/or proposals are created, proposed, and performed for the member 1012. This information may also be used by the task facilitation service 1002 to anticipate, identify, and present appropriate or intelligent interactions with the member 1012 (e.g., in response to member 1012 queries, needs, and/or goals).

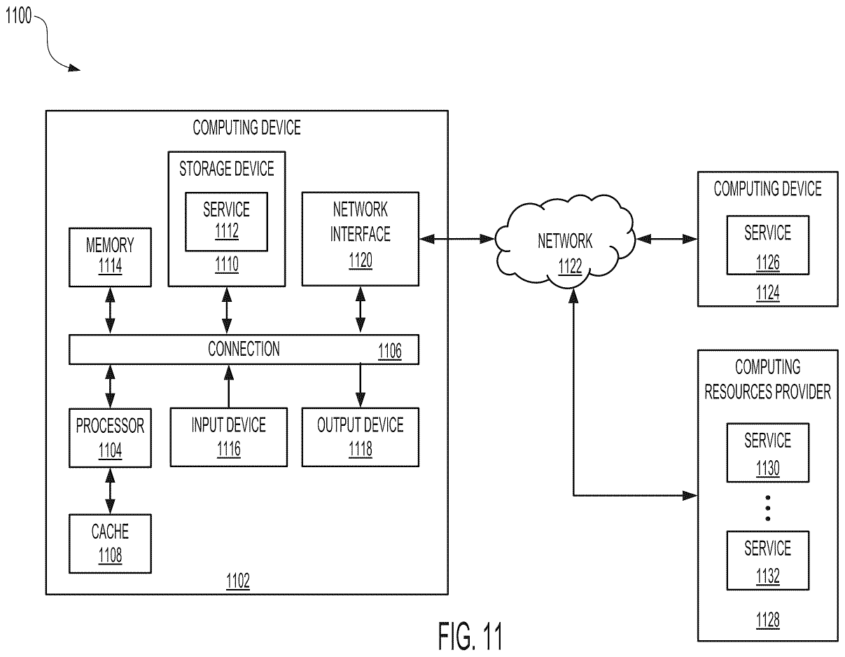

FIG. 11 illustrates a computing system architecture 1100, including various components in electrical communication with each other, in accordance with some embodiments. The example computing system architecture 1100 illustrated in FIG. 11 includes a computing device 1102, which has various components in electrical communication with each other using a connection 1106, such as a bus, in accordance with some implementations. The example computing system architecture 1100 includes a processing unit 1104 that is in electrical communication with various system components, using the connection 1106, and including the system memory 1114. In some embodiments, the system memory 1114 includes read-only memory (ROM), random-access memory (RAM), and other such memory technologies including, but not limited to, those described herein. In some embodiments, the example computing system architecture 1100 includes a cache 1108 of high-speed memory connected directly with, in close proximity to, or integrated as part of the processor 1104. The system architecture 1100 can copy data from the memory 1114 and/or the storage device 1110 to the cache 1108 for quick access by the processor 1104. In this way, the cache 1108 can provide a performance boost that decreases or eliminates processor delays in the processor 1104 due to waiting for data. Using modules, methods and services such as those described herein, the processor 1104 can be configured to perform various actions. In some embodiments, the cache 1108 may include multiple types of cache including, for example, level one (L1) and level two (L2) cache. The memory 1114 may be referred to herein as system memory or computer system memory. The memory 1114 may include, at various times, elements of an operating system, one or more applications, data associated with the operating system or the one or more applications, or other such data associated with the computing device 1102.

Other system memory 1114 can be available for use as well. The memory 1114 can include multiple different types of memory with different performance characteristics. The processor 1104 can include any general purpose processor and one or more hardware or software services, such as service 1112 stored in storage device 1110, configured to control the processor 1104 as well as a special-purpose processor where software instructions are incorporated into the actual processor design. The processor 1104 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 1104 can be a microprocessor, a microcontroller, a digital signal processor (“DSP”), or a combination of these and/or other types of processors. In some embodiments, the processor 1104 can include multiple elements such as a core, one or more registers, and one or more processing units such as arithmetic logic units (ALU), floating point units (FPU), graphics processing units (GPU), physics processing units (PPU), neural processing units (NPU), tensor processing units (TPU), digital system processing (DSP) units, or combinations of these and/or other such processing units. The processor 1104 can be implemented through different processor architectures, such as Reduced Instruction Set Computing (RISC) architectures (e.g., RISC-V, etc.), Advanced RISC Machine (ARM) architectures, and the like.

The computing device 1102 can further include one or more dedicated processors that are configured to exclusively perform machine learning algorithm and/or artificial intelligence calculations and processes. Similar to the processor 1104, the one or more dedicated processors implemented on the computing device 1102 can be a completely self-contained computing system, containing multiple cores or processors, connectors (e.g., buses), memory, memory controllers, caches, etc. In some embodiments, such a self-contained computing system with multiple cores is symmetric or asymmetric. The one or more dedicated processors can include multiple elements such as a core, one or more registers, and one or more processing units such as ALUs, FPUs, GPUs, PPUs, NPUs, TPUs, DSP units, or combinations of these and/or other such processing units. Similar to the processor 1104, these one or more dedicated processors can be implemented through different processor architectures, such as RISC architectures (e.g., RISC-V, etc.), ARM architectures, and the like. This implementation of dedicated processors to exclusively perform machine learning algorithm and/or artificial intelligence calculations and processes provides acceleration of the machine learning algorithm and/or artificial intelligence processes, thereby reducing computing device latency while supporting the operations of the computing device 1102 as described herein.

To enable user interaction with the computing system architecture 1100, an input device 1116 can represent any number of input mechanisms, such as a microphone for speech, a touch-sensitive screen for gesture or graphical input, keyboard, mouse, motion input, pen, and other such input devices. An output device 1118 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 1100. In some embodiments, the input device 1116 and/or the output device 1118 can be coupled to the computing device 1102 using a remote connection device such as, for example, a communication interface such as the network interface 1120 described herein. In such embodiments, the communication interface can govern and manage the input and output received from the attached input device 1116 and/or output device 1118. As may be contemplated, there is no restriction on operating on any particular hardware arrangement and accordingly the basic features here may easily be substituted for other hardware, software, or firmware arrangements as they are developed.

In some embodiments, the storage device 1110 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described above, the storage device 1110 can include hardware and/or software services such as service 1112 that can control or configure the processor 1104 to perform one or more functions including, but not limited to, the methods, processes, functions, systems, and services described herein in various embodiments. In some embodiments, the hardware or software services can be implemented as modules. As illustrated in example computing system architecture 1100, the storage device 1110 can be connected to other parts of the computing device 1102 using the system connection 1106. In an embodiment, a hardware service or hardware module such as service 1112, that performs a function can include a software component stored in a non-transitory computer-readable medium that, in connection with the necessary hardware components, such as the processor 1104, connection 1106, cache 1108, storage device 1110, memory 1114, input device 1116, output device 1118, and so forth, can carry out the functions such as those described herein.

The disclosed processed for generating and executing experience recommendations can be performed using a computing system such as the example computing system illustrated in FIG. 11, using one or more components of the example computing system architecture 1100. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some embodiments, the processor can be configured to carry out some or all of methods and functions for generating and executing experience recommendations described herein by, for example, executing code using a processor such as processor 1104 wherein the code is stored in memory such as memory 1114 as described herein. One or more of a user device, a provider server or system, a database system, or other such devices, services, or systems may include some or all of the components of the computing system such as the example computing system illustrated in FIG. 11, using one or more components of the example computing system architecture 1100 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 1128. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 1104 can be a conventional microprocessor such as an Intel® microprocessor, an AMD® microprocessor, a Motorola® microprocessor, or other such microprocessors. The processor 1104 can include multiple elements such as a core, one or more registers, and one or more processing units such as ALUs, FPUs, GPUs, PPUs, NPUs, TPUs, DSP units, or combinations of these and/or other such processing units. The processor 1104, as noted above, can be implemented through different processor architectures, such as RISC architectures (e.g., RISC-V, etc.), ARM architectures, and the like. One of skill in the relevant art will recognize that the terms “machine-readable (storage) medium” or “computer-readable (storage) medium” include any type of device that is accessible by the processor.

The memory 1114 can be coupled to the processor 1104 by, for example, a connector such as connector 1106, or a bus. As used herein, a connector or bus such as connector 1106 is a communications system that transfers data between components within the computing device 1102 and may, in some embodiments, be used to transfer data between computing devices. The connector 1106 can be a data bus, a memory bus, a system bus, or other such data transfer mechanism. Examples of such connectors include, but are not limited to, an industry standard architecture (ISA″ bus, an extended ISA (EISA) bus, a parallel AT attachment (PATA″ bus (e.g., an integrated drive electronics (IDE) or an extended IDE (EIDE) bus), or the various types of parallel component interconnect (PCI) buses (e.g., PCI, PCIe, PCI-104, etc.).

The memory 1114 can include RAM including, but not limited to, dynamic RAM (DRAM), static RAM (SRAM), synchronous dynamic RAM (SDRAM), non-volatile random access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 1114 can also include magnetic or optical data storage media including read-only (e.g., CD ROM and DVD ROM) or otherwise (e.g., CD or DVD). The memory can be local, remote, or distributed.

As described above, the connector 1106 (or bus) can also couple the processor 1104 to the storage device 1110, which may include non-volatile memory or storage and which may also include a drive unit. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data is may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 1110. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 1106 can also couple the processor 1104 to a network interface device such as the network interface 1120. The interface can include one or more of a modem or other such network interfaces including, but not limited to those described herein. It will be appreciated that the network interface 1120 may be considered to be part of the computing device 1102 or may be separate from the computing device 1102. The network interface 1120 can include one or more of an analog modem, Integrated Services Digital Network (ISDN) modem, cable modem, token ring interface, satellite transmission interface, or other interfaces for coupling a computer system to other computer systems. In some embodiments, the network interface 1120 can include one or more input and/or output (I/O) devices. The I/O devices can include, by way of example but not limitation, input devices such as input device 1116 and/or output devices such as output device 1118. For example, the network interface 1120 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and decendents, Xenix™, SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 1102 can be connected to one or more additional computing devices such as computing device 1124 via a network 1122 using a connection such as the network interface 1120. In such embodiments, the computing device 1124 may execute one or more services 1126 to perform one or more functions under the control of, or on behalf of, programs and/or services operating on computing device 1102. In some embodiments, a computing device such as computing device 1124 may include one or more of the types of components as described in connection with computing device 1102 including, but not limited to, a processor such as processor 1104, dedicated processors to exclusively perform and accelerate machine learning algorithm and/or artificial intelligence calculations and processes, a connection such as connection 1106, a cache such as cache 1108, a storage device such as storage device 1110, memory such as memory 1114, an input device such as input device 1116, and an output device such as output device 1118. In such embodiments, the computing device 1124 can carry out the functions such as those described herein in connection with computing device 1102. In some embodiments, the computing device 1102 can be connected to a plurality of computing devices such as computing device 1124, each of which may also be connected to a plurality of computing devices such as computing device 1124. Such an embodiment may be referred to herein as a distributed computing environment.

The network 1122 can be any network including an internet, an intranet, an extranet, a cellular network, a Wi-Fi network, a local area network (LAN), a wide area network (WAN), a satellite network, a Bluetooth® or Bluetooth® Low Energy (BLE) network, a virtual private network (VPN), a public switched telephone network, an infrared (IR) network, an internet of things (IoT network), a Zigbee network, a Z-Wave network, or any other such network or combination of networks. Communications via the network 1122 can be wired connections, wireless connections, or combinations thereof. Communications via the network 1122 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), Z-Wave, Zigbee, Matter, Message Queuing Telemetry Transport (MQTT), WebSocket, and other such communications protocols.

Communications over the network 1122, within the computing device 1102, within the computing device 1124, or within the computing resources provider 1128 can include information, which also may be referred to herein as content. The information may include text, graphics, audio, video, haptics, and/or any other information that can be provided to a user of the computing device such as the computing device 1102. In an embodiment, the information can be delivered using a transfer protocol such as Hypertext Markup Language (HTML), Extensible Markup Language (XML), JavaScript®, Cascading Style Sheets (CSS), JavaScript® Object Notation (JSON), Protocol Buffers (Protobuf), MQTT, Matter, and other such protocols and/or structured languages, including any variants implementing Secure Sockets Layer (SSL), Transport Layer Security (TLS), or any other security protocols. The information may first be processed by the computing device 1102 and presented to a user of the computing device 1102 using forms that are perceptible via sight, sound, smell, taste, touch, or other such mechanisms. In some embodiments, communications over the network 1122 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 1102 and/or the computing device 1124 can be connected to a computing resources provider 1128 via the network 1122 using a network interface such as those described herein (e.g. network interface 1120). In such embodiments, one or more systems (e.g., service 1130 and service 1132) hosted within the computing resources provider 1128 (also referred to herein as within “a computing resources provider environment”) may execute one or more services to perform one or more functions under the control of, or on behalf of, programs and/or services operating on computing device 1102 and/or computing device 1124. Systems such as service 1130 and service 1132 may include one or more computing devices such as those described herein to execute computer code to perform the one or more functions under the control of, or on behalf of, programs and/or services operating on computing device 1102 and/or computing device 1124.

For example, the computing resources provider 1128 may provide a service, operating on service 1130 to store data for the computing device 1102 when, for example, the amount of data that the computing device 1102 exceeds the capacity of storage device 1110. In another example, the computing resources provider 1128 may provide a service to first instantiate a virtual machine (VM) on service 1132, use that VM to access the data stored on service 1132, perform one or more operations on that data, and provide a result of those one or more operations to the computing device 1102. Such operations (e.g., data storage and VM instantiation) may be referred to herein as operating “in the cloud,” “within a cloud computing environment,” or “within a hosted virtual machine environment,” and the computing resources provider 1128 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 1128 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, serverless hosting, virtual reality (VR) systems, and augmented reality (AR) systems. Various techniques to facilitate such services include, but are not be limited to, virtual machines, virtual storage, database services, system schedulers (e.g., hypervisors), resource management systems, various types of short-term, mid-term, long-term, and archival storage devices, etc.

As may be contemplated, the systems such as service 1130 and service 1132 may implement versions of various services (e.g., the service 1112 or the service 1126) on behalf of, or under the control of, computing device 1102 and/or computing device 1124. Such implemented versions of various services may involve one or more virtualization techniques so that, for example, it may appear to a user of computing device 1102 that the service 1112 is executing on the computing device 1102 when the service is executing on, for example, service 1130. As may also be contemplated, the various services operating within the computing resources provider 1128 environment may be distributed among various systems within the environment as well as partially distributed onto computing device 1124 and/or computing device 1102.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a key pad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 1102) include, but is not limited to, desktop computers, laptop computers, server computers, hand-held computers, tablets, smart phones, personal digital assistants, digital home assistants, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), and one or more processing units such as ALUs, FPUs, GPUs, PPUs, NPUs, TPUs, DSP units, or combinations of these and/or other such processing units or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram (e.g., the processes illustrated in FIGS. 7-9). Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital assistant (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system or simulator, such as a virtual version of one of the aforementioned devices that may be hosted on another computer device such as the computer device 1102.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method, comprising:
continuously receiving ambient data associated with a user, wherein the ambient data is continuously received through a set of communications channels associated with different sensors and a gateway device, and wherein the ambient data is continuously received to dynamically detect any predictive anomalies associated with the user;
processing the ambient data through a machine learning algorithm to detect one or more predictive anomalies associated with the user, wherein the machine learning algorithm is trained using a dataset of sample ambient data and corresponding sample predictive anomalies associated with the sample ambient data;
associating the one or more predictive anomalies with a category according to a set of characteristics associated with the one or more predictive anomalies and the user;
identifying one or more actions performable to address the one or more predictive anomalies, wherein the one or more actions are identified according to the category and a set of preferences associated with the user; and
executing the one or more actions through the gateway device to address the one or more predictive anomalies.

2. The computer-implemented method of claim 1, wherein the one or more actions include transmitting one or more commands, and wherein when the one or more commands are received at a device, the device executes the one or more commands to address the one or more predictive anomalies.

3. The computer-implemented method of claim 1, further comprising:
receiving new ambient data associated with the user, wherein the new ambient data is received after the one or more actions are executed;
determining that the one or more predictive anomalies are ongoing; and
identifying new actions performable to address the one or more predictive anomalies.

4. The computer-implemented method of claim 1, wherein the category corresponds to a severity of the one or more predictive anomalies with regard to the user.

5. The computer-implemented method of claim 1, wherein the one or more actions include transmitting one or more notifications to a set of entities, and wherein the set of entities is identified according to the category and the set of preferences.

6. The computer-implemented method of claim 1, further comprising:
dynamically generating device data associated with the gateway device, wherein the device data indicates a level of performance for the gateway device; and
automatically transmitting the device data, wherein when the device data is received at a remote monitoring system, the remote monitoring system performs a set of functions according to the level of performance.

7. The computer-implemented method of claim 1, further comprising:
parsing the ambient data into regulated data and unregulated data, wherein the regulated data and the unregulated data are processed through the machine learning algorithm according to corresponding encryption requirements and access control policies.

8. A system, comprising:
one or more processors; and
memory storing thereon instructions that, as a result of being executed by the one or more processors, cause the system to:
continuously receive ambient data associated with a user, wherein the ambient data is continuously received through a set of communications channels associated with different sensors and a gateway device, and wherein the ambient data is continuously received to dynamically detect any predictive anomalies associated with the user;
process the ambient data through a machine learning algorithm to detect one or more predictive anomalies associated with the user, wherein the machine learning algorithm is trained using a dataset of sample ambient data and corresponding sample predictive anomalies associated with the sample ambient data;
associate the one or more predictive anomalies with a category according to a set of characteristics associated with the one or more predictive anomalies and the user;
identify one or more actions performable to address the one or more predictive anomalies, wherein the one or more actions are identified according to the category and a set of preferences associated with the user; and
execute the one or more actions through the gateway device to address the one or more predictive anomalies.

9. The system of claim 8, wherein the one or more actions include transmitting one or more commands, and wherein when the one or more commands are received at a device, the device executes the one or more commands to address the one or more predictive anomalies.

10. The system of claim 8, wherein the instructions further cause the system to:
receive new ambient data associated with the user, wherein the new ambient data is received after the one or more actions are executed;
determine that the one or more predictive anomalies are ongoing; and
identify new actions performable to address the one or more predictive anomalies.

11. The system of claim 8, wherein the category corresponds to a severity of the one or more predictive anomalies with regard to the user.

12. The system of claim 8, wherein the one or more actions include transmitting one or more notifications to a set of entities, and wherein the set of entities is identified according to the category and the set of preferences.

13. The system of claim 8, wherein the instructions further cause the system to:
dynamically generate device data associated with the gateway device, wherein the device data indicates a level of performance for the gateway device; and
automatically transmit the device data, wherein when the device data is received at a remote monitoring system, the remote monitoring system performs a set of functions according to the level of performance.

14. The system of claim 8, wherein the instructions further cause the system to:
parse the ambient data into regulated data and unregulated data, wherein the regulated data and the unregulated data are processed through the machine learning algorithm according to corresponding encryption requirements and access control policies.

15. A non-transitory computer-readable storage medium storing thereon executable instructions that, as a result of being executed by one or more processors of a computer system, cause the computer system to:
continuously receive ambient data associated with a user, wherein the ambient data is continuously received through a set of communications channels associated with different sensors and a gateway device, and wherein the ambient data is continuously received to dynamically detect any predictive anomalies associated with the user;
process the ambient data through a machine learning algorithm to detect one or more predictive anomalies associated with the user, wherein the machine learning algorithm is trained using a dataset of sample ambient data and corresponding sample predictive anomalies associated with the sample ambient data;
associate the one or more predictive anomalies with a category according to a set of characteristics associated with the one or more predictive anomalies and the user;
identify one or more actions performable to address the one or more predictive anomalies, wherein the one or more actions are identified according to the category and a set of preferences associated with the user; and
execute the one or more actions through the gateway device to address the one or more predictive anomalies.

16. The non-transitory computer-readable storage medium of claim 15, wherein the one or more actions include transmitting one or more commands, and wherein when the one or more commands are received at a device, the device executes the one or more commands to address the one or more predictive anomalies.

17. The non-transitory computer-readable storage medium of claim 15, wherein the executable instructions further cause the computer system to:
receive new ambient data associated with the user, wherein the new ambient data is received after the one or more actions are executed;
determine that the one or more predictive anomalies are ongoing; and
identify new actions performable to address the one or more predictive anomalies.

18. The non-transitory computer-readable storage medium of claim 15, wherein the category corresponds to a severity of the one or more predictive anomalies with regard to the user.

19. The non-transitory computer-readable storage medium of claim 15, wherein the one or more actions include transmitting one or more notifications to a set of entities, and wherein the set of entities is identified according to the category and the set of preferences.

20. The non-transitory computer-readable storage medium of claim 15, wherein the executable instructions further cause the computer system to:
dynamically generate device data associated with the gateway device, wherein the device data indicates a level of performance for the gateway device; and
automatically transmit the device data, wherein when the device data is received at a remote monitoring system, the remote monitoring system performs a set of functions according to the level of performance.

21. The non-transitory computer-readable storage medium of claim 15, wherein the executable instructions further cause the computer system to:
parse the ambient data into regulated data and unregulated data, wherein the regulated data and the unregulated data are processed through the machine learning algorithm according to corresponding encryption requirements and access control policies.
